(19) United States
(12) Patent Application Publication
(10) Pub. No.: US 2026/0221730 A1
(43) Pub. Date: Jul. 30, 2026

(54) MODULAR HIGH-DENSITY POWER DISTRIBUTION PANEL FOR LARGE CRITICAL LOADS

(71) Applicant: IEM New Sub 2, LLC, Fremont, CA (US)

(72) Inventors: Ashok Kulkarni, Fremont, CA (US); Frank Cavezza, San Jose, CA (US); Jorge Alfaro, Pico Rivera, CA (US)

(21) Appl. No.: 19/036,105

(22) Filed: Jan. 24, 2025

(51) Int. Cl. H02B 1/20; H01H 71/02; H02B 1/04; H02B 1/06; H02B 1/32; H02B 1/56; H02G 5/02

(52) U.S. Cl. CPC H02B 1/20; H01H 71/0271; H02B 1/043; H02B 1/06; H02B 1/32; H02B 1/565; H02G 5/025

(57) ABSTRACT

A modular high-density power distribution panel assembly (MHDPDPA) for large critical loads includes a high current-rated panel defined by a configurable height; and a bus bar assembly. The panel flexibly accommodates a configurable number of breakers of different types and sizes in each row with a high current density. The breakers include 80%-rated and 100%-rated breakers, rated at currents from about 100 amperes to about 1200 amperes. The bus bar assembly includes a main bus, bus kits selectively configured for accommodating and supporting the breakers of different currents and current densities, and back stabs that feed the main bus. The MHDPDPA is rated at currents from about 2000 amperes to about 6000 amperes; has a compact footprint; achieves a high current density per row and a high short circuit rating of about 200 kiloamperes at 480 V and about 100 kiloamperes at 600 V; and is free of cooling requirements.

### BACKGROUND

Modern data centers demand an ever-growing and substantial amount of power to sustain their operations. The advent of artificial intelligence (AI) for various applications has created a need for large data centers with increasing power densities. The power demand for data centers is expected to grow exponentially over the next decade. The current use of data centers and cloud computing is also growing exponentially. Therefore, the power requirement for data centers is expected to grow rapidly over the next decade.

Due to the need for optimizing the use of space in data centers, there is a need to increase the power density of the data centers and that of servers inside these data centers that provide computing and storage, to minimize the foot print. As the power demand in data centers and other industrial applications continues to grow, there is a need for power distribution panels that are rated at high currents, for example, about 6000 amperes (A), to interface with low voltage switchgears that are rated at 6000 A. Moreover, there is a need for increasing the density of a power distribution panel to meet the needs of power-hungry data centers. Furthermore, there is a need to reduce the footprint of the power distribution panel, thereby requiring a power distribution panel with a substantially high current density. In addition, there is a need for a modular power distribution panel that allows a flexible implementation of different current ratings, and a need for accommodating multiple breakers of different brands in a single modular power distribution panel for supply chain applications.

Power distribution panels typically accommodate multiple different components, for example, circuit breakers, current transformers, voltage transformers, power monitors, and other control devices that generate heat during normal operation. Excessive heat can lead to reduced efficiency, increased wear and tear, and even system failures. Therefore, effective cooling is required to maintain the reliability and longevity of power distribution panels. However, conventional methods of cooling power distribution panels, for example, implementing air conditioning systems such as fans, liquid cooling systems, etc., are complex, require additional components such as pumps, hoses, reservoirs, coolants, etc., which are expensive and require installation labor, additional maintenance, and modifications to the power distribution panels. In addition, the added complexity of these cooling systems will reduce the critical reliability of power distribution for mission critical applications. Hence, there is a need for a naturally cooled power distribution panel free of cooling systems. Furthermore, for safety in big cities and other large metro areas where the available short circuit current is substantially high, there is a need for power distribution panels tested to a substantially high short circuit rating up to 200 kA.

Hence, there is a long-felt need for a modular high-density power distribution panel assembly for allowing optimal addition of large critical loads as capacity requirements grow over time, while meeting the stringent demands of flexible power distribution architectures and custom power distribution solutions for data centers and other critical applications and addressing the above-recited problems of the related art.

### BRIEF DESCRIPTION OF THE DRAWINGS

The following detailed description of the invention is better understood when read in conjunction with the appended drawings. For illustrating the embodiments herein, exemplary constructions of the embodiments are shown in the drawings. However, the embodiments herein are not limited to the specific components and structures disclosed herein. In an embodiment, various structural elements are employed depending on design choices of a system designer. The description of a component or a structure referenced by a numeral in a drawing is applicable to the description of that component or structure shown by that same numeral in any subsequent drawing herein. The terms “front”, “rear”, “side”, “top”, “bottom”, etc., are based on an orientation or a positional relationship shown in the appended drawings, and are recited merely for describing the embodiments herein, rather than indicating or implying that the device, component, or structure referenced must have a particular orientation or position or must be constructed and operated in a particular orientation, and therefore should not be construed as limiting the embodiments herein.

FIG. 1A illustrates a front elevation view of an embodiment of a modular high-density power distribution panel assembly for large critical loads.

FIG. 1B illustrates a rear elevation view of the embodiment of the modular high-density power distribution panel assembly shown in FIG. 1A.

FIG. 1C illustrates a side elevation view of the embodiment of the modular high-density power distribution panel assembly shown in FIG. 1A.

FIG. 2A illustrates a front elevation view of another embodiment of the modular high-density power distribution panel assembly for large critical loads.

FIG. 2B illustrates a rear elevation view of the embodiment of the modular high-density power distribution panel assembly shown in FIG. 2A.

FIG. 2C illustrates a side elevation view of the embodiment of the modular high-density power distribution panel assembly shown in FIG. 2A.

FIG. 3A illustrates an isometric view of an embodiment of a chassis of the modular high-density power distribution panel assembly.

FIG. 3B illustrates a front elevation view of the embodiment of the chassis of the modular high-density power distribution panel assembly shown in FIG. 3A.

FIG. 3C illustrates a top plan view of the embodiment of the chassis of the modular high-density power distribution panel assembly shown in FIG. 3A.

FIG. 3D illustrates a side elevation view of the embodiment of the chassis of the modular high-density power distribution panel assembly shown in FIG. 3A.

FIG. 4A illustrates a perspective view of an embodiment of a bus bar assembly of the modular high-density power distribution panel assembly.

FIG. 4B illustrates a top plan view of the embodiment of the bus bar assembly shown in FIG. 4A.

FIG. 4C illustrates a front elevation view of the embodiment of the bus bar assembly shown in FIG. 4A.

FIG. 4D illustrates a side elevation view of the embodiment of the bus bar assembly shown in FIG. 4A.

FIG. 4E illustrates an enlarged view of a portion marked A in FIG. 4D.

FIG. 4F illustrates a front elevation view of the bus bar assembly, showing a configuration of a main bus comprising drilled and tapped holes.

FIG. 4G illustrates an enlarged back view of a top portion of an embodiment of the bus bar assembly of the modular high-density power distribution panel assembly.

FIG. 4H illustrates an enlarged front view of a top portion of an embodiment of the bus bar assembly of the modular high-density power distribution panel assembly.

FIG. 4I illustrates another enlarged front view of a top portion of an embodiment of the bus bar assembly of the modular high-density power distribution panel assembly.

FIGS. 5A-5D illustrate elevation views of embodiments of back stabs of the modular high-density power distribution panel assembly.

FIG. 6 illustrates size and number guidelines for the back stabs of the modular high-density power distribution panel assembly illustrated in FIGS. 4A-4B, FIG. 4D, and FIGS. 5A-5B.

FIG. 7 illustrates tabular representations showing center feed with back stabs panel rating size to back stabs.

FIGS. 8A-8B illustrate perspective, assembled and disassembled views of an embodiment of a bus kit for twin XT1 breakers, each with a 125-ampere frame, respectively.

FIGS. 9A-9B illustrate perspective, assembled and disassembled views of an embodiment of a bus kit for twin XT2 breakers, each with a 125-ampere frame, respectively.

FIGS. 10A-10B illustrate perspective, assembled and disassembled views of an embodiment of a bus kit for twin XT3 breakers, each with a 225-ampere frame, respectively.

FIGS. 11A-11B illustrate perspective, assembled and disassembled views of an embodiment of a bus kit for twin XT4 breakers, each with a 250-ampere frame, respectively.

FIGS. 12A-12B illustrate perspective, assembled and disassembled views of an embodiment of a bus kit for twin XT5 breakers, each with a 400-ampere frame, respectively.

FIG. 12C illustrates an enlarged view of a portion marked B in FIG. 12B.

FIGS. 13A-13B illustrate perspective, assembled and disassembled views of an embodiment of a bus kit for a XT5 breaker with a 600-ampere frame.

FIGS. 14A-14B illustrate perspective, assembled and disassembled views of an embodiment of a bus kit for an XT6 breaker with an 800-ampere frame, respectively.

FIGS. 15A-15B illustrate perspective, assembled and disassembled views of an embodiment of a bus kit for a XT6 breaker with an 800-ampere frame, respectively.

FIG. 15C illustrates a perspective view of an embodiment of an A-phase and a C-phase bus strap of XT6 800 A breaker of the modular high-density power distribution panel assembly.

FIG. 15D illustrates a perspective view of an embodiment of a B-phase bus strap of XT6 800 A breaker of the modular high-density power distribution panel assembly.

FIG. 15E illustrates the use of an anti-turn clip to secure a bus strap with a single bolt.

FIGS. 15F-15I illustrate various embodiments of the anti-turn clips used to secure the bus straps.

FIGS. 16A-16B illustrate perspective, assembled and disassembled views of an embodiment of a bus kit for a XT7 breaker with a 1200-ampere frame, respectively.

FIGS. 17A-17B illustrates a perspective view of an embodiment of bus strap of twin ABB 800 A XT6 breaker of the modular high-density power distribution panel assembly.

FIGS. 17C-17D illustrates a perspective view of an embodiment of bus strap of Square D twin 800 A circuit breaker of the modular high-density power distribution panel assembly.

FIGS. 18A-18B illustrates a perspective view of an embodiment of bus strap of twin 600 A Eaton breakers.

FIGS. 18C-18D illustrates a perspective view of an embodiment of bus strap of twin 600 A for Siemens breakers.

FIG. 19A illustrates a front view of an embodiment of a modular high-density power distribution panel assembly with an 80″ height.

FIG. 19B illustrates a front perspective view of an embodiment of a modular high-density power distribution panel assembly with 14×800 A XT6 breakers.

FIG. 19C illustrates a front perspective view of an embodiment of a modular high-density power distribution panel assembly with 6×800 A XT6 breakers+8×250 A XT4 breakers+8×125 A XT2 breakers.

FIG. 19D illustrates a front perspective view of an embodiment of a modular high-density power distribution panel assembly with 8×800 A XT6 breakers+3×1200 A XT7 breakers.

FIG. 19E illustrates a front perspective view of an embodiment of a modular high-density power distribution panel assembly with 5×1200 A XT7 breakers+6×400 A XT4 breakers.

FIG. 20A illustrates a special chassis jig used to install the bus bars of the main bus of the modular high-density power distribution panel assembly at a proper location.

FIG. 20B illustrates the jig shown in FIG. 20A that ensures proper spacing of the main bus.

FIGS. 20C-20D illustrate breaker bus straps accurately spaced using a breaker jig 2002 designed for an ABB XT2 breaker.

FIG. 20E illustrates one side of the twin-mounted XT2 breakers 904 with bus straps 901 and 902 all properly spaced to mount the XT2 breakers 904 on the other side of the MHDPDPA 100.

### DETAILED DESCRIPTION OF THE INVENTION

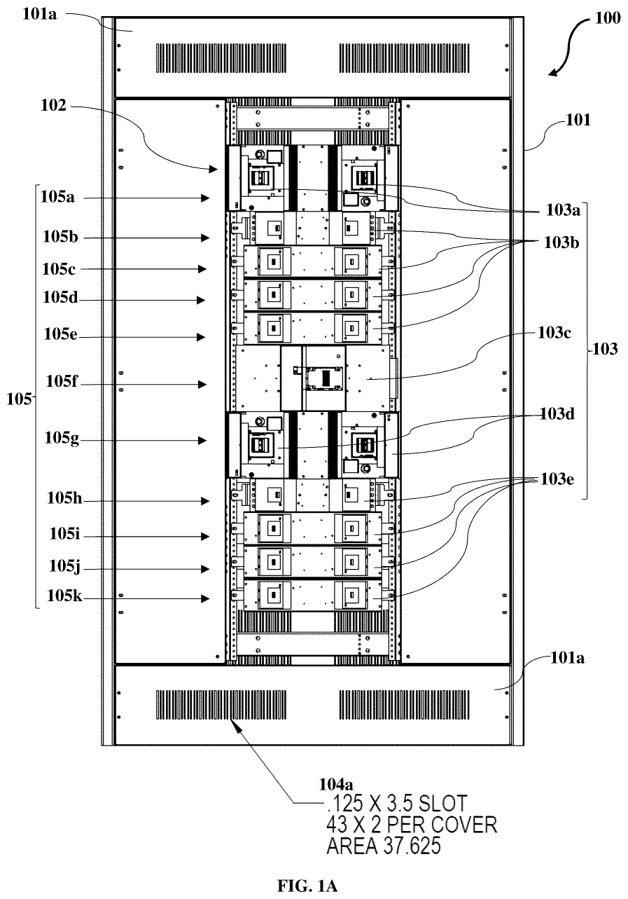

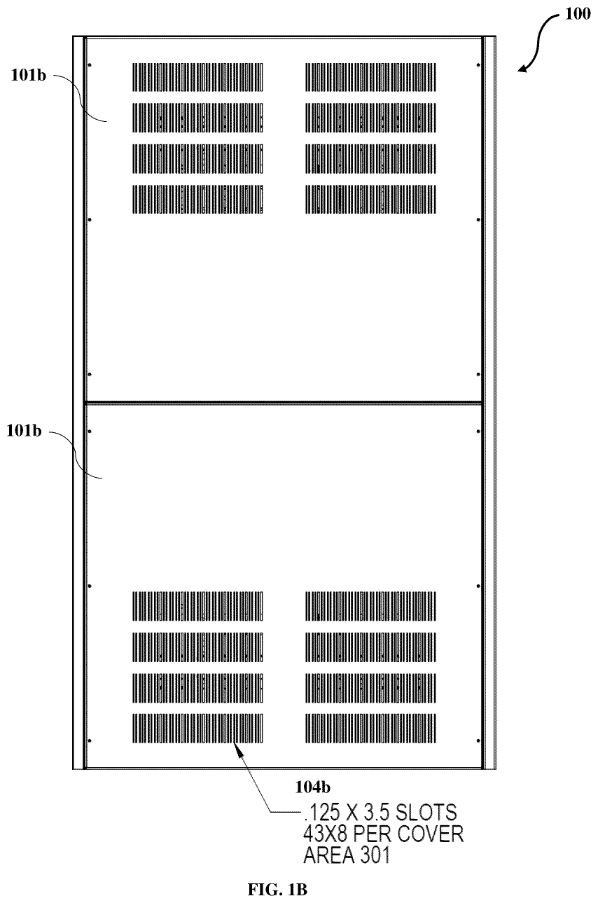

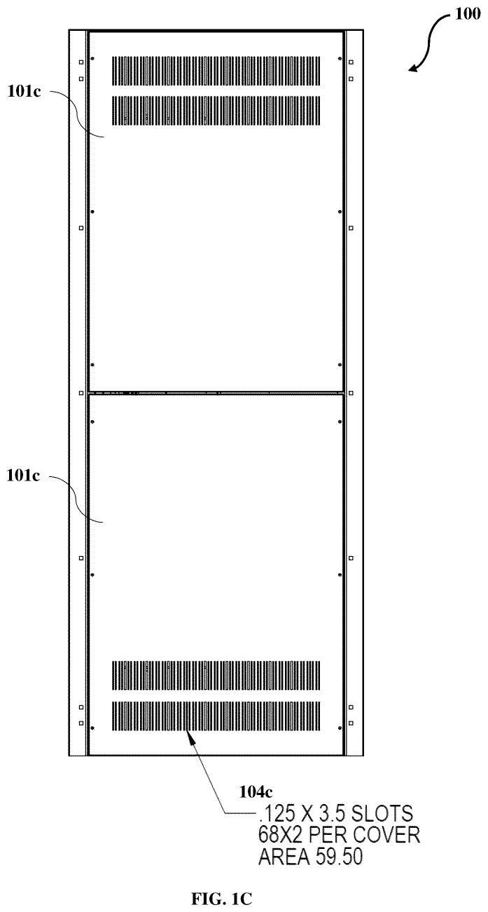

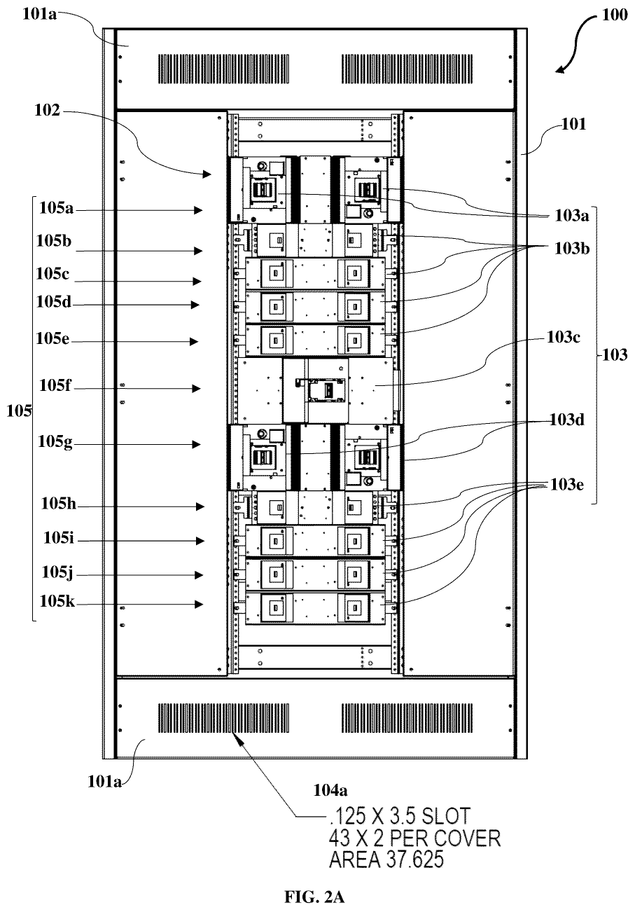

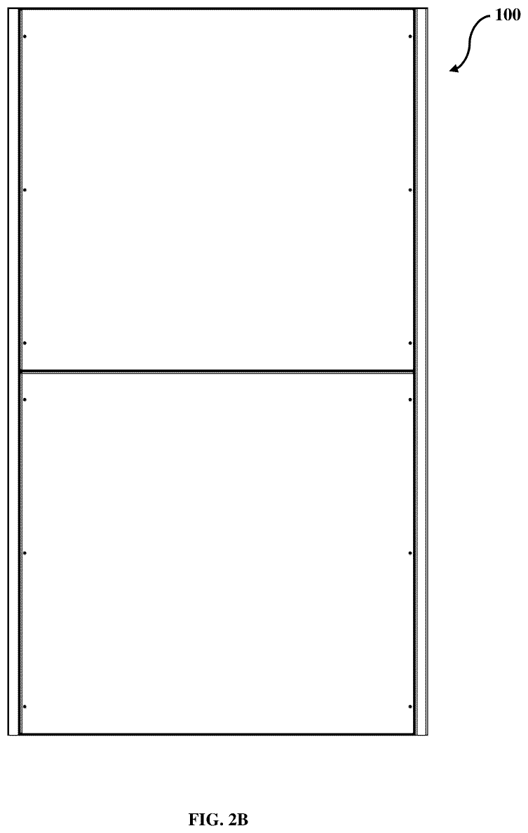

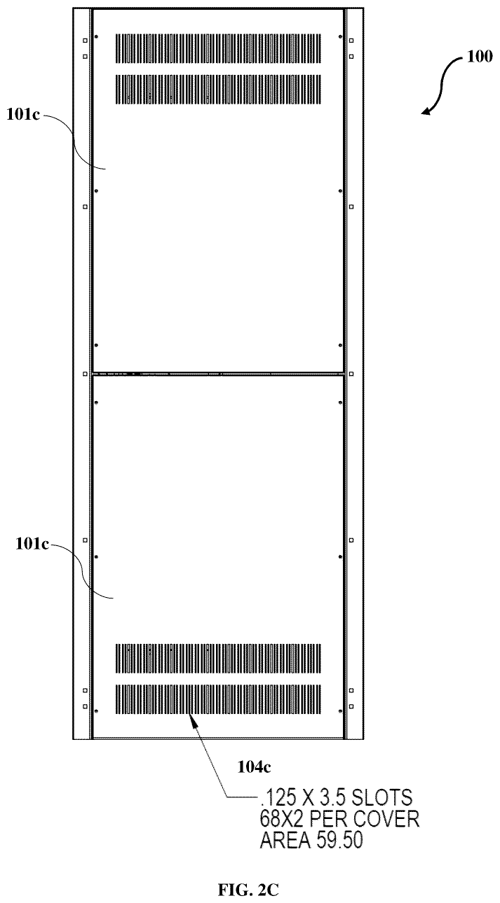

The system disclosed herein addresses the above-recited long-felt need for a modular high-density power distribution panel assembly (MHDPDPA) 100 illustrated in FIGS. 1A-1C and FIGS. 2A-2C, for allowing optimal addition of large critical loads as capacity requirements grow over time, while meeting the stringent demands of flexible power distribution architectures and custom power distribution solutions for data centers and other critical applications. In an embodiment, the MHDPDPA 100 is configured as a high-density, 6000 ampere (6000 A)-rated, modular power distribution panel to meet the growing power needs of data centers in a small enclosure 101 illustrated in FIGS. 1A-1C and FIGS. 2A-2C. In another embodiment, the MHDPDPA 100 is configured as a high-density, 3000 A-rated or 4500 A-rated modular power distribution panel using, for example, twin 800 A and/or 1200 A feeder breakers. The MHDPDPA 100 can be rated up to 6000 A.

FIG. 1A, FIG. 1B, and FIG. 1C illustrate a front elevation view, a rear elevation view, and a side elevation view of an embodiment of a modular high-density power distribution panel assembly (MHDPDPA) 100 for large critical loads, respectively. The MHDPDPA 100 is configured to be rated at currents ranging, for example, from about 2000 amperes (2000 A) to about 6000 amperes (6000 A) and at a substantially high current density, free of cooling requirements. In an embodiment, the MHDPDPA 100 is configured to achieve a high short circuit rating of about 200 kiloamperes (kA) at 480V AC and about 100 kA at 600V. The MHDPDPA 100 is configured to meet stringent building codes, seismic standards, and predefined electrical requirements comprising, for example, American National Standards Institute (ANSI) requirements, Underwriters Laboratories (UL) requirements, Canadian Standards Association (CSA) requirements, National Fire Protection Association (NFPA) requirements such as NFPA 70 requirements, National Electric Code (NEC) standards, etc., for safety and reliability.

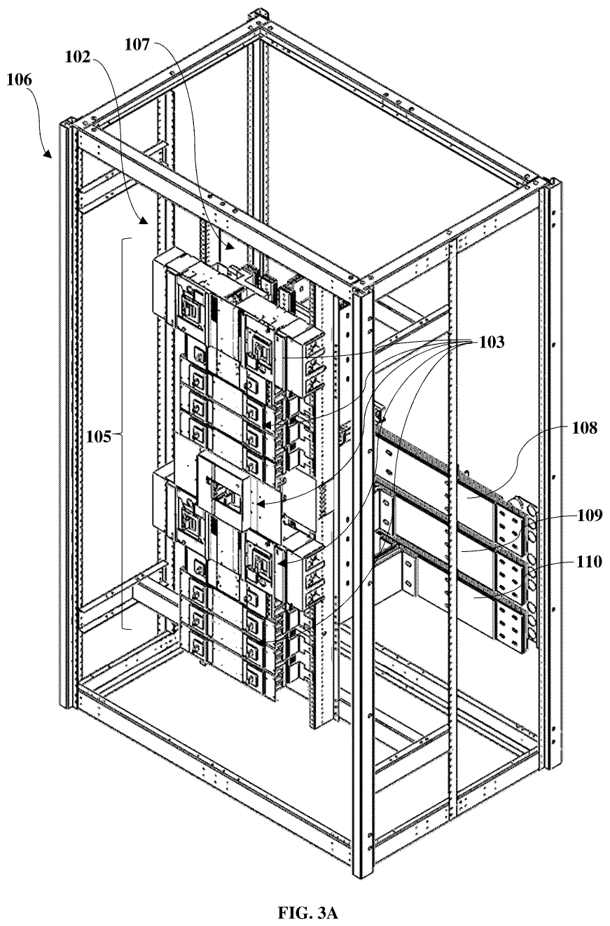

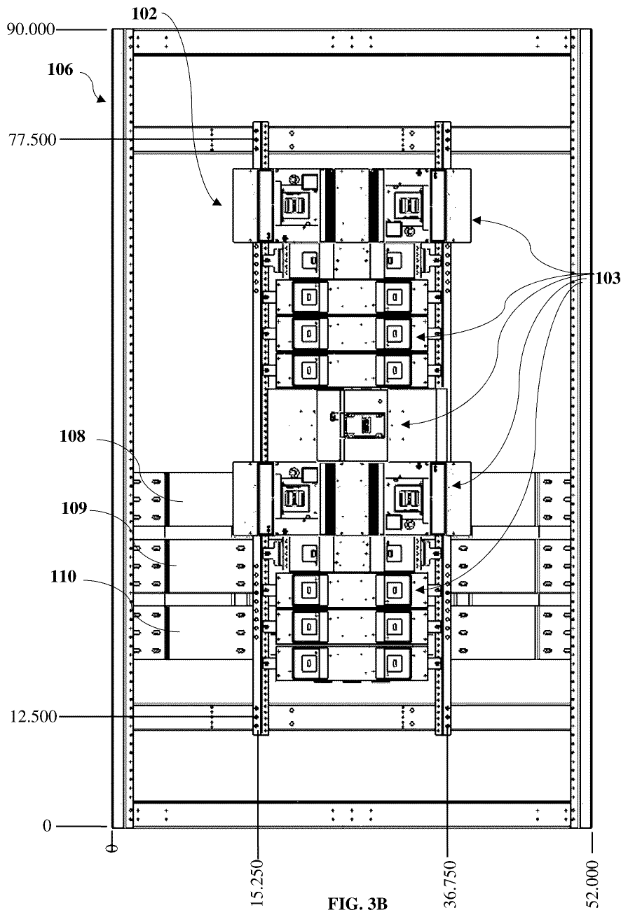

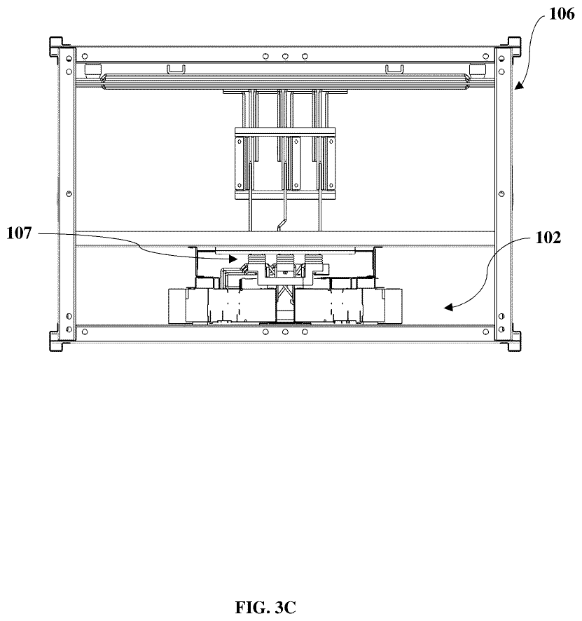

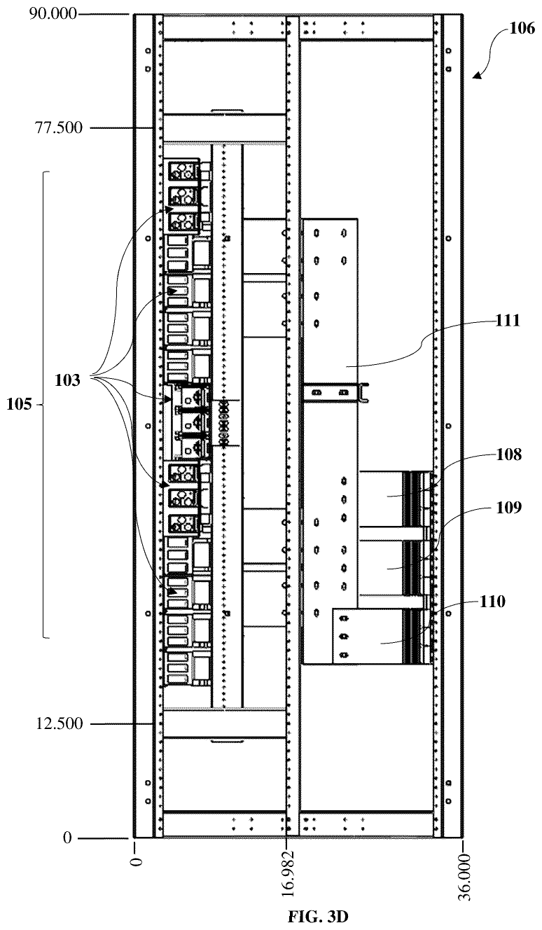

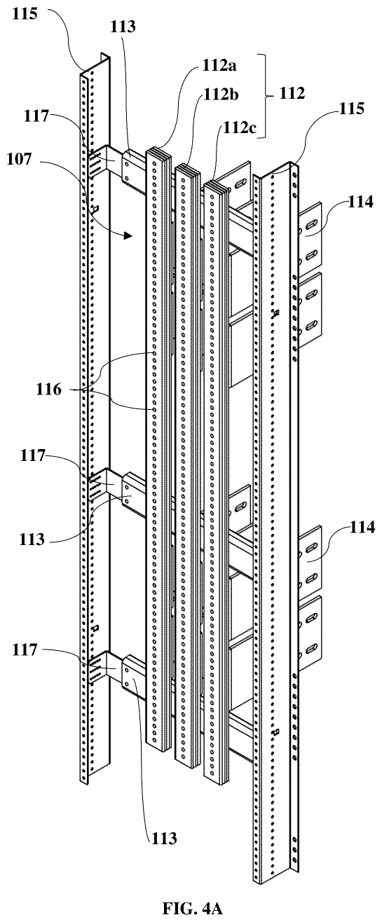

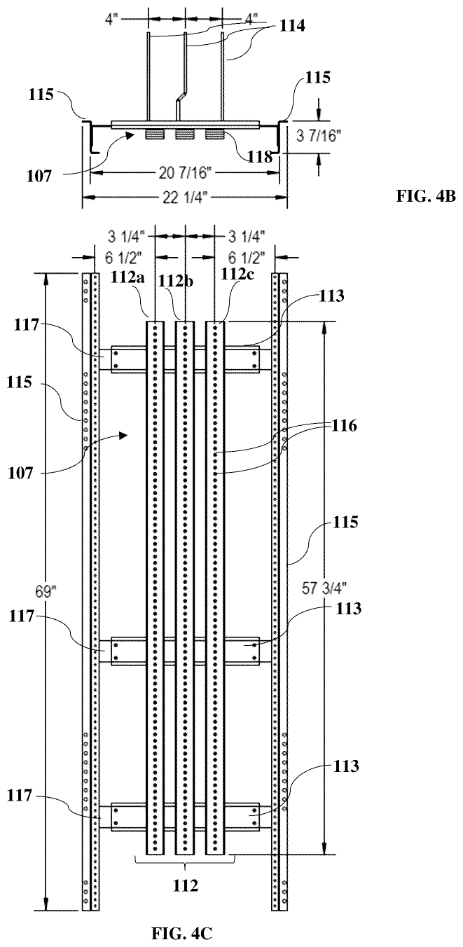

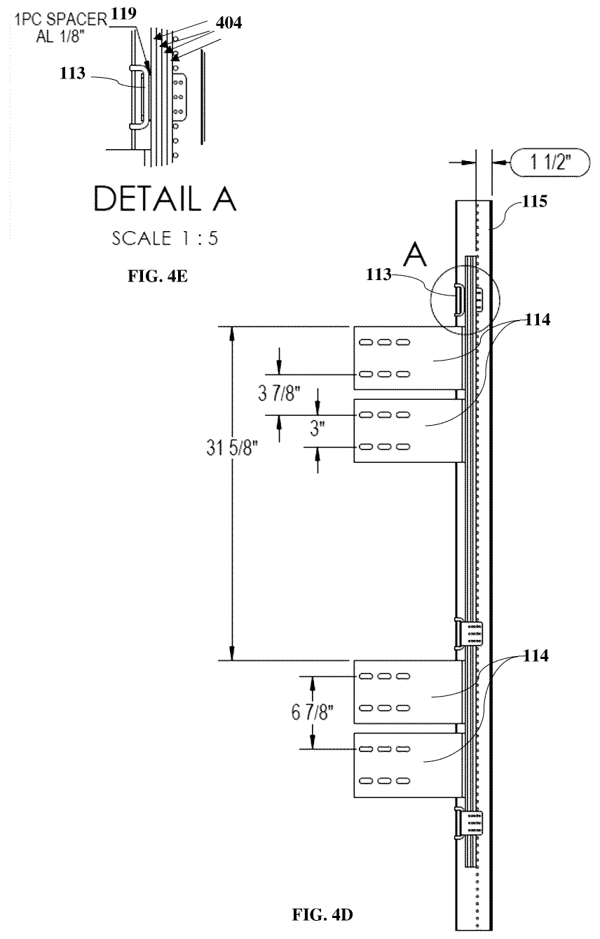

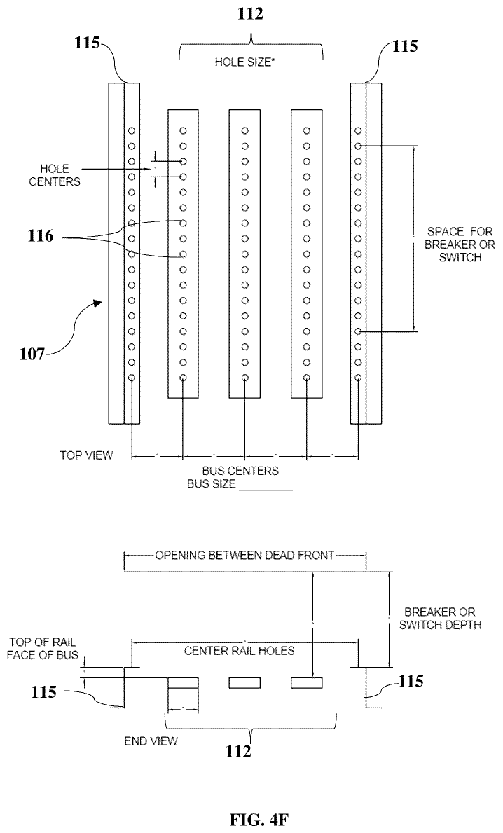

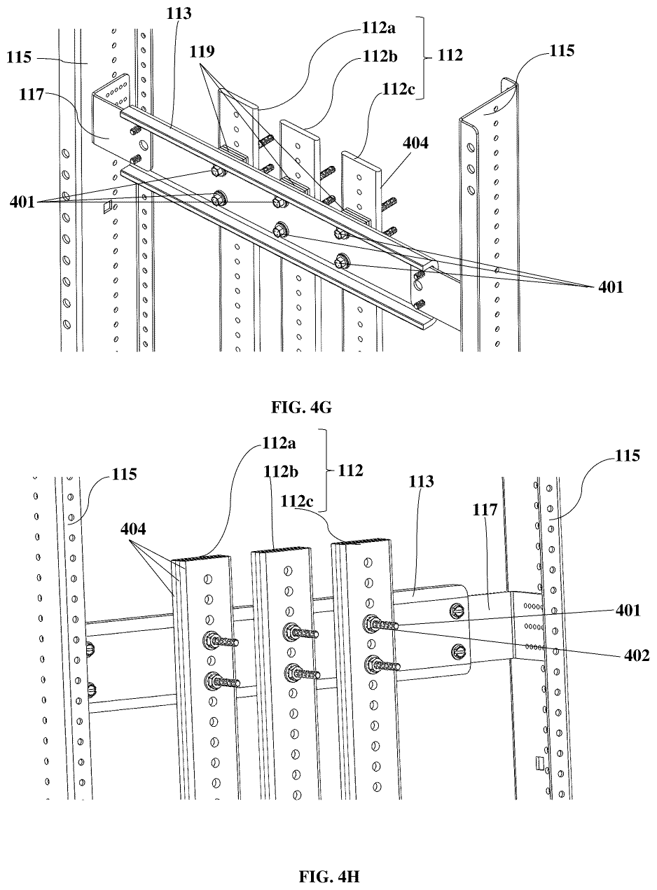

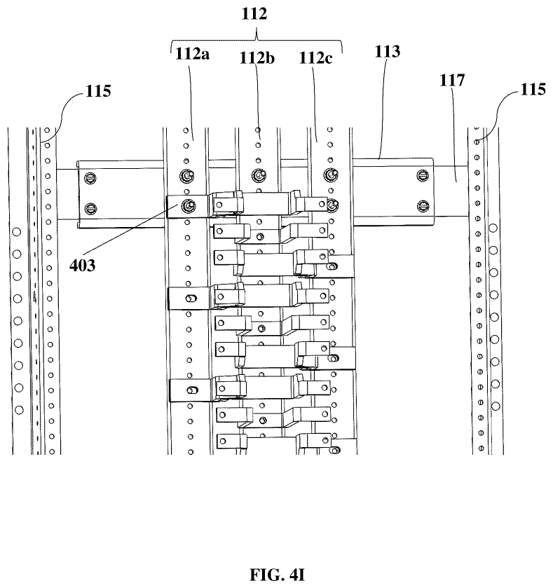

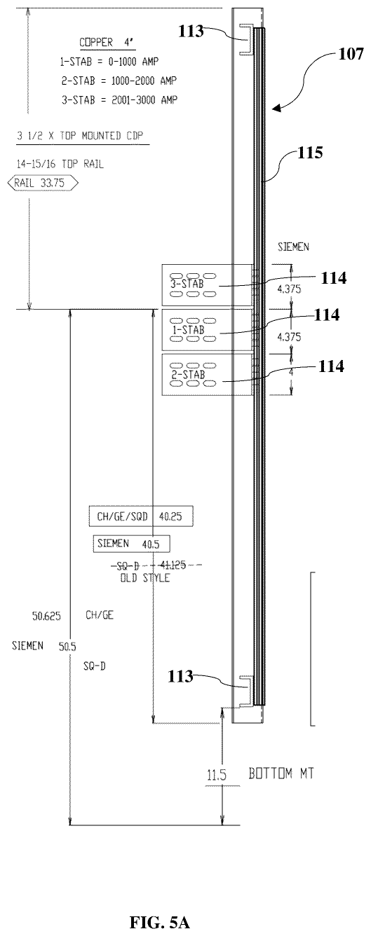

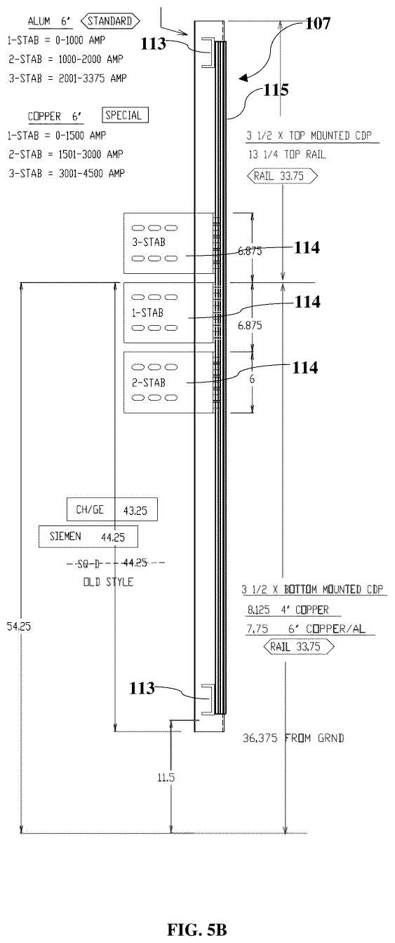

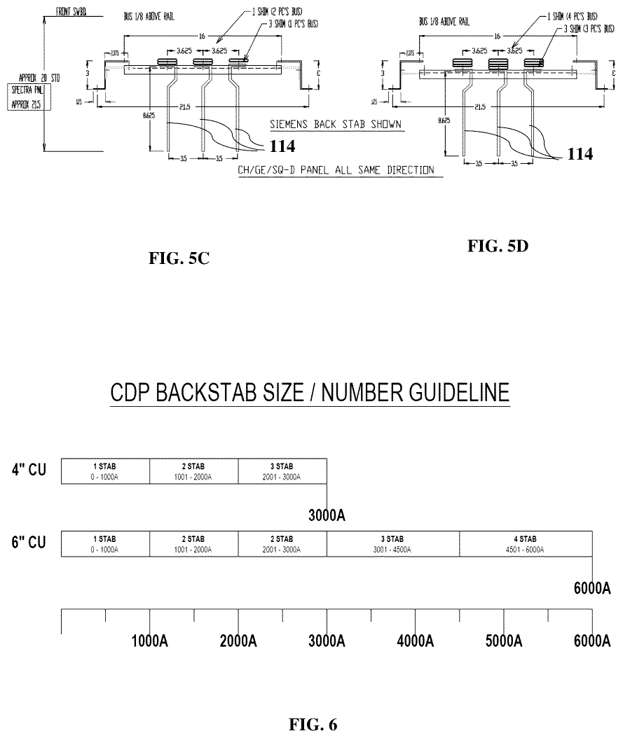

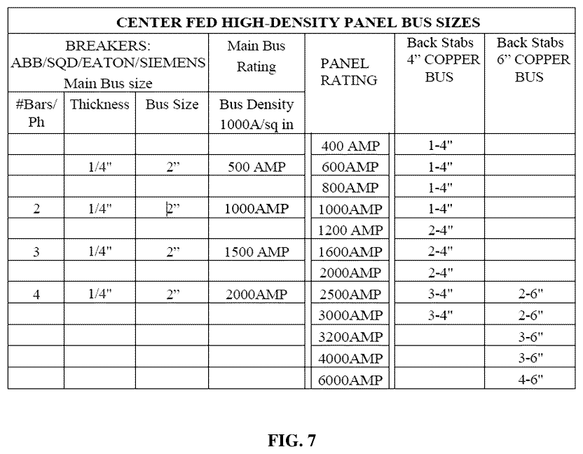

The modular high-density power distribution panel assembly (MHDPDPA) 100 comprises an electrical enclosure 101, a panel 102 accommodated with the electrical enclosure 101, a bus bar assembly 107 illustrated in FIG. 3A and FIGS. 4A-4C, and multiple back stabs 114 illustrated in FIG. 3A and FIGS. 4A-4C illustrated in FIG. 4A, FIG. 4D, and FIGS. 5A-5B. In an embodiment, the electrical enclosure 101 is of a cuboidal shape as illustrated in FIGS. 1A-1C. In an embodiment, the electrical enclosure 101 comprises slots 104a, 104b, and 104c configured on front covers 101a, rear covers 101b, and side covers 101c thereof as illustrated in FIG. 1A, FIG. 1B, and FIG. 1C, respectively. In an example, the electrical enclosure 101 comprises two sets of 43 slots on each of the front covers 104a; eight sets of 43 slots on each of the rear covers 101b; and two sets of 68 slots on each of the side covers 101c as illustrated in FIGS. 1A-1C. The slots 104a, 104b, and 104c provide adequate ventilation to prevent overheating of critical loads. The slots 104a, 104b, and 104c allow air to flow through the electrical enclosure 101, thereby assisting in the dissipation of heat, pressure equalization, and maintenance of safe operating temperatures within the electrical enclosure 101, resulting in a naturally cooled MHDPDPA 100.

The panel 102 is configured with a substantially high current rating. The panel 102 is configured to flexibly accommodate a configurable number of breakers 103 of multiple different types and sizes in each of multiple rows 105 with a substantially high current density. For example, the panel 102 illustrated in FIG. 1A, flexibly accommodates about 21 breakers 103 of multiple different types and sizes in multiple rows 105 with a substantially high current density. In this example, the panel 102 flexibly accommodates twin-mounted breakers 103a in the row 105a; twin-mounted breakers 103b in the rows 105b, 105c, 105d, and 105e; a single-mounted breaker 103c in the row 105f; twin-mounted breakers 103d in the row 105g; and twin-mounted breakers 103e in the rows 105h, 105i, 105j, and 105k, as illustrated in FIG. 1A. As illustrated in Table 1 below, the panel 102 is configured to accommodate and support breakers of different types from different brands and/or manufacturers, for example, Asea Brown Boveri (ABB) Ltd., Siemens AG, Eaton Corporation, Schneider Electric, etc., that offer flexibility to a customer and minimize the impact of supply chain disruptions.

In an embodiment, the panel 102 is configured as a convertible distribution panel (CDP) which is a modular, group mounted distribution panel comprising feeder breakers ranging, for example, from about 100 amperes (100 A) to about 1200 A. The panel 102 is defined by a configurable height “X” as illustrated in Table 1 below. The height of the panel 102 is adjustable based on the number of feeder breakers required for a given application. Furthermore, the configurable height of the panel 102 corresponds to the width of the largest one of the breakers 103. In an embodiment, the panel 102 is a wall-mounted power distribution panel. In another embodiment, the panel 102 is a standalone or freestanding floor-mounted power distribution panel. In another embodiment, the panel 102 is a switchboard-mounted power distribution panel. In an embodiment, the panel 102 is configured to be connected to a low voltage switchgear via the bus bar assembly 107. Furthermore, in an embodiment, the panel 102 is configured as a main lug only panel with a main lug only assembly. In another embodiment, the panel 102 is configured as a panel with a main breaker assembly where a main breaker is installed. In another embodiment, the panel 102 is configured as a switchboard bus-connected panel with a main breaker assembly. In this embodiment, the panel 102 is bus-connected to a switchboard for added flexibility. In an embodiment, the switchboard accommodates the main breaker, a transfer switch, multiple sources, etc., to provide a flexible power distributed solution to a data center. Furthermore, the switchboard is bus-connected to the panel 102 to save space and minimize the footprint.

The breakers 103 comprise, for example, 80%-rated breakers and 100%-rated breakers, rated at currents ranging, for example, from about 100 amperes (100 A) to about 1200 amperes (1200 A). In an embodiment, 90° C.-rated cables are used for output connections of the 100%-rated breakers. In an embodiment, the breakers rated 100 A through 800 A are twin-mounted in each of the rows 105 on the panel 102. In an embodiment, the breakers rated 800 A that are twin-mounted in each of the rows 105 on the panel 102 achieve a current rating of, for example, about 1600 A per row of breakers. In another embodiment, the breakers rated 600 A, 800 A, 1000 A and 1200 A are single-mounted in each of the rows 105 on the panel 102. In an embodiment, the breakers 103 are configured to accommodate 80%-rated loads and 100%-rated loads for high current density and application flexibility.

The bus bar assembly 107 comprises a main bus 112 constituted by multiple bus bars 112a, 112b, and 112c operably coupled to the panel 102 as illustrated in FIG. 4A, FIG. 4C, and FIG. 4F. The bus bars 112a, 112b, and 112c define an A-phase bus, a B-phase bus, and a C-phase bus of the main bus 112, respectively. The main bus 112 is configured as a vertical bus bar (V-bar), the size of which depends on the rating of the panel 102. In an example, for 4000 A and 6000 A panels, four pieces of a 2-inch bus is used for each phase. In another example, the maximum length of the vertical bus bar is 9X and the maximum height of the panel is 10X. The panel 102 is defined by the “X” height which corresponds to the width of the largest breaker used. The largest breaker is rated, for example, at about 1200 A. Therefore, the width of the 1200 A breaker is the dimension “X”. Since there are slight variations in the widths of breakers of different types, the value of X for the panel 102 is also slightly different depending on the type of the breaker used. The following table summarizes the X values for different breaker types. In an embodiment, the main bus 112 comprises drilled and tapped holes 116 configured thereon as illustrated in FIG. 4A, FIG. 4C, and FIG. 4F, based on each of the types of the breakers 103. The distance between drilled and tapped holes 116 in the main bus 112, that is, in the vertical bus bar, also depends on the type of the breaker. Table 1 below summarizes the X dimensions, V-bar dimensions, and hole spacing in the V-bar for various types of breakers 103.

TABLE 1
Panel X and V-bar Dimensions of the MHDPDPA

| | | | Spacing | |
|---|---|---|---|---|
| Circuit Breaker | Breaker | V-bar | between V-bar | Maximum CDP |
| Type | Width X | height | holes | panel height |
| GE, ABB, | 8.25″ | 8.25X | 1.375″ | 10X |
| Schneider | | | | |
| Siemens | 9.0″ | 9.0X | 1.25″ | 10X |
| Eaton | 8.25″ | 8.25X | 1.375″ | 10X |

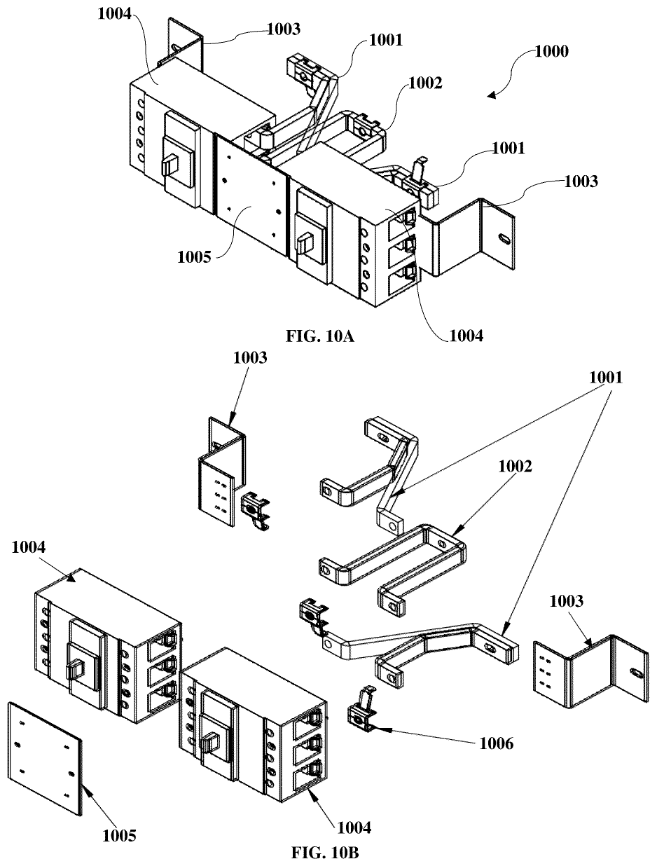

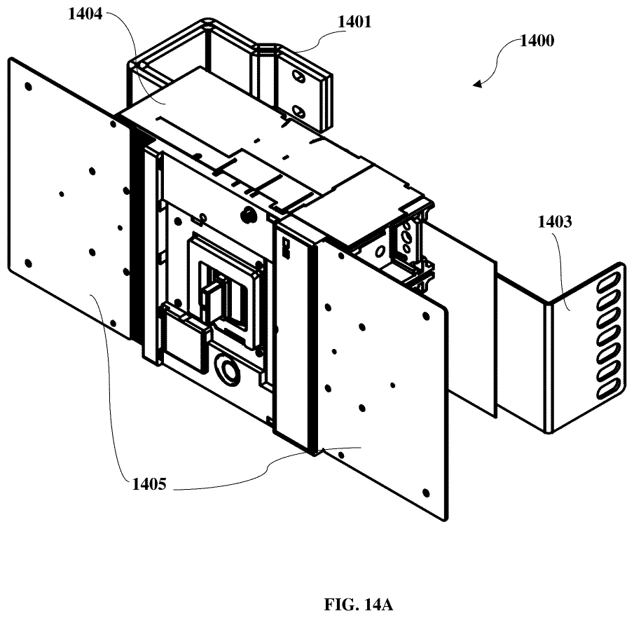

The bus bar assembly 107 further comprises bus kits 800, 900, 1000, 1100, 1200, 1300, 1400, 1500, and 1600 as illustrated in FIGS. 8A-8B, FIGS. 9A-9B, FIGS. 10A-10B, FIGS. 11A-11B, FIGS. 12A-12C, FIGS. 13A-13B, FIGS. 14A-14B, FIGS. 15A-15C, and FIGS. 16A-16B, respectively. The bus kits 800, 900, 1000, 1100, 1200, 1300, 1400, 1500, and 1600 are selectively configured to accommodate and support the configurable number of breakers 103 of different types and sizes of different currents and current densities. The bus kits 800, 900, 1000, 1100, 1200, 1300, 1400, 1500, and 1600 comprise bus straps 801/802, 901/902, 1001/1002, 1101/1102, 1201/1202, 1301/1302, 1401/1402, 1501/1502, and 1601/1602 as illustrated in FIGS. 8A-8B, FIGS. 9A-9B, FIGS. 10A-10B, FIGS. 11A-11B, FIGS. 12A-12C, FIGS. 13A-13B, FIGS. 14A-14B, FIGS. 15A-15C, and FIGS. 16A-16B, respectively. The bus straps 801/802, 901/902, 1001/1002, 1101/1102, 1201/1202, 1301/1302, 1401/1402, 1501/1502, and 1601/1602 are configured to connect input terminals of the breakers 103 of different types and sizes to the main bus 112. The bus kits 800, 900, 1000, 1100, 1200, 1300, 1400, 1500, and 1600 cover the bus straps 801/802, 901/902, 1001/1002, 1101/1102, 1201/1202, 1301/1302, 1401/1402, 1501/1502, and 1601/1602 for various breaker currents. The back stabs 114 are implemented in the bus bar assembly 107 and are configured to feed the main bus 112 and support the configurable number of breakers 103 of different types and sizes. In an embodiment, each of the back stabs 114 is configured as a bus to connect the main bus 112 to a cross bus in a switchboard style distribution panel. It should be noted that each breaker 103 gets an A-phase and a C-phase bus-a longer and a shorter bus. If the feeder breakers 103 are twin mounted, as illustrated in FIGS. 8A and 8B, A-phase bus 801a for the left breaker 804c would be a C-phase bus 801b for the right breaker 804d and vice versa. If it is a single breaker 103/1304 per row, as illustrated in FIG. 13B, then A-phase 1301c-a and C-phase bus 1301a-c names depend on whether the breaker 103/1304 output is on the left side or right side, but each breaker 103/1304 will have a longer bus and a shorter bus.

The construction of the modular high-density power distribution panel assembly (MHDPDPA) 100 disclosed above relates to a wall-mounted power distribution panel or panelboard rated, for example, up to about 1200 A, or a switchboard style distribution panel rated, for example, about 2000 A to about 6000 A. In an embodiment, the main bus 112 of the bus bar assembly 107 is directly connected to a switchboard cross bus (not shown) in the switchboard-mounted power distribution panel. Apart from the enclosure 101, the difference between the wall-mounted power distribution panel and the switchboard style distribution panel is the back stab 114 that feeds the main bus 112 in the higher ampere-rated switchboard style distribution panel. Table 2 below shows an overview of different types of panels incorporated in the MHDPDPA 100 and their ratings.

TABLE 2
Overview of panel types and the associated panel details

| | | Freestanding or | Switchboard- |
|---|---|---|---|
| Assembly Type | Wall-mounted | Standalone | mounted |
| Interior | Steel box (called | Switchboard | Switchboard |
| installed in | “can”) | section | section(s) |
| Finished with | Swingouts, Door- | Swingouts/Side | Swingouts/Side |
| | in-Door | Panels | Panels |
| MHDPDPA | Wall | Floor | Floor |
| mounted to | | | |
| MHDPDPA | Main | Main Breaker | Main Breaker |
| fed by | Breaker (MB) | (MB) Main Lugs | (MB) Main Lugs |
| | Main | (MLO) | (MLO) |
| | Lugs (MLO) | Center-fed | Center-fed |
| | | with bus (CF) | with bus (CF) |
| Max Ampacity | 1,200 A | 2,000 A-6,000 A | 2,000 A-6,000 A |
| [A] | | | |
| Bus Material | Cu only | | |
| Certification | UL67 - | UL891 - | UL891 - |
| Standard | Panelboards | Switchboards | Switchboards |

The modular high-density power distribution panel assembly (MHDPDPA) 100 is configured as a freestanding panel with a high current density and rated, for example, about 2000 A to about 6000 A. In an example, twin 800 A feeder breakers that are 100%-rated already account for 1600 A. The range, however, covers a small panel of a lower rating, if required. Example dimensions for configuring the MHDPDPA 100 as a freestanding panel are shown in Table 3 below.

TABLE 3
Dimensions of a freestanding panel

| Panel Ampacity [A] | | 400-1000 | 1,001-2,000 | 2,001-6,000 |
|---|---|---|---|---|
| X-size | | 2X, 3X, 3.5X, 4X, 5X, 6X, 7X, 7.5X | | |
| Height [″] | | 65 min, 90 max | | |
| Width [″] | | 38, 42, 48 | | |
| Depth [″] | NEMA 1 | 20 | 28 | 36 |
| | NEMA 3R | +4 or +11 vestibule | | |
| Access Required | | Front only | Side and rear | Side and rear |

The modular high-density power distribution panel assembly (MHDPDPA) 100 is configured to obtain a panel rating of, for example, about 2000 A to about 6000 A by center fed bus bars. In an example, the width of the MHDPDPA 100 is about 38 inches, when the feeder breakers are rated at 600 A or lower. If the feeder breakers are rated at 800 A or lower, the width of the MHDPDPA 100 is, for example, about 42 inches, and for feeder breakers rated 1200 A or lower, the width of the MHDPDPA 100 is about 48 inches. The minimum height of the MHDPDPA 100 is about 65 inches and the maximum height of the MHDPDPA 100 is about 90 inches as shown in Table 3 above. The heights of the MHDPDPA 100 are 3.5X and 7X. The actual panel height inside the enclosure 101 is the height of the main bus 112 or the V-bar height of the panel 102 shown in Table 1.

Table 4 below shows critical dimensions of a switchboard-mounted panel. The dimensions and ratings are similar to the freestanding panel disclosed above. In the switchboard-mounted panel, the main bus 112 of the panel 102 is directly connected to the switchboard cross bus 108, 109, and 110 as shown in FIG. 3A. For ratings of 2000 A and higher, the main bus 112 is center fed in different configurations. In an embodiment, the MHDPDPA 100 is configured to be a part of a switchgear lineup.

TABLE 4
Switchboard-mounted power distribution panel

| | | |
|---|---|---|
| Ampacity [A] | | 400-6,000 |
| X-size | | 2X, 3X, 3.5X, 4X, 5X, 6X, 7X, 7.5X |
| Height [″] | | 90 max (based on SWBD height) |
| Width [″] | | 38, 42, 48 |
| Depth [″] | | 36 min (various depending |
| | | on SWBD depth) |
| Enclosure Rating | NEMA | 1, 3R |
| Access Required | | Side and rear |
| Certification Standard | | UL 891 - Switchboards |

In an embodiment, the MHDPDPA 100 further comprises lugs selectively configured for cable connections within the enclosure 101.

FIG. 2A, FIG. 2B, and FIG. 2C illustrate a front elevation view, a rear elevation view, and a side elevation view of another embodiment of the modular high-density power distribution panel assembly (MHDPDPA) 100 for large critical loads, respectively. Although FIG. 1A and FIG. 2A illustrate about eleven (11) rows of breakers comprising twin-mounted breakers and single-mounted breakers in a single panel 102, the scope of the MHDPDPA 100 disclosed herein is not limited to 11 rows of breakers, but extends to include any number of rows of breakers of different types or brands, sizes, currents, and current densities. In an example, circuit breakers rated 100 A through 800 A are twin-mounted on the panel 102, that is, two circuit breakers per row, while 1000 A and 1200 A breakers are single-mounted on the panel 102, that is, one breaker per row. In an example, by using twin 800 A breakers in one row nose-to-nose, the MHDPDPA 100 has the highest current rating of 1600 A per row of breakers. In another example, the MHDPDPA 100 is configured to accommodate larger single loads by using a 1200 A breaker with one breaker per row. The panel 102 is flexible to accommodate different configurations, for example, different sizes and number of breakers installed, where the breakers are 80%-rated or 100%-rated. The power density of the MHDPDPA 100 is increased substantially by installing 100%-rated feeder breakers. For increased flexibility, distribution breakers of the MHDPDPA 100 are configured to accommodate, for example, 80%-rated loads, or for much higher density, 100%-rated loads.

The panel 102 of the modular high-density power distribution panel assembly (MHDPDPA) 100 is configured with substantially high current ratings of, for example, about 2000 A, 4000 A, 5000 A, and 6000 A; feeder breakers rated at currents ranging, for example, from about 100 A through to about 1200 A; twin-mounted breakers rated at currents ranging, for example, from 100 A through 800 A; and single-mounted breakers rated at currents 1000 A and 1200 A; 80%-rated or 100%-rated breakers. The MHDPDPA 100 is configured with short circuit ratings, for example, up to about 200 kiloamperes (kA) at 480 volts (V) and 100 kA at 600V. The panel 102 of the MHDPDPA 100 is configured as a standalone main lug only (MLO) panel or a switchboard bus-connected panel. The panel 102 of the MHDPDPA 100 is naturally cooled and does not require cooling equipment, for example, cooling fans, liquid cooling equipment, etc. In an embodiment, slots 104a and 104c are configured on the front covers 101a and the side covers 101c of the electrical enclosure 101 as illustrated in FIG. 2A and FIG. 2C, respectively, for naturally cooling the MHDPDPA 100. In an example, the electrical enclosure 101 comprises two sets of 43 slots on each of the front covers 104a; and two sets of 68 slots on each of the side covers 101c as illustrated in FIG. 2A and FIG. 2C. The MHDPDPA 100 has a small footprint and accordingly maximum power density. The MHDPDPA 100 meets stringent building codes such as the International Building Code (IBC), seismic standards, and the American National Standards Institute (ANSI), Underwriters Laboratories (UL), Canadian Standards Association (CSA), National Fire Protection Association 70 (NFPA70), and National Electric Code (NEC) standards.

FIGS. 3A-3D respectively illustrate an isometric view, a front elevation view, a top plan view, and a side elevation view of an embodiment of a chassis 106 of the modular high-density power distribution panel assembly (MHDPDPA) 100, respectively. In an embodiment, the chassis 106 is of an open cuboidal shape as illustrated in FIGS. 3A-3D. The panel 102 is disposed within the chassis 106 and flexibly accommodates a configurable number of breakers 103 of different types and sizes in each of the rows 105 with a substantially high current density. The bus bar assembly 107 provides support to the breakers 103 disposed on the rows 105 of the panel 102.

FIGS. 4A-4D respectively illustrate a perspective view, a top plan view, a front elevation view, and a side elevation view of an embodiment of the bus bar assembly 107 of the modular high-density power distribution panel assembly (MHDPDPA) 100, respectively. In an embodiment, the bus bars 112a, 112b, and 112c of the main bus 112 are attached to the bus support members 113, which are attached to opposing Z-rails 115 via support brackets 117 of the panel 102 as illustrated in FIG. 4A and FIG. 4C. Each bus bar 112a, 112b, and 112c is constructed by stacking multiple conductive metal strips/bars 404, for example, copper, on top of one another, as shown in FIGS. 4G and 4H. The main bus 112 serves as the central conductor for distributing electrical power throughout the panel 102. In an embodiment of a main lug only assembly, the main bus 112 comprises holes for mounting lugs. The bus support members 113 are configured, for example, as horizontal Glastic U shaped support brackets, i.e., Glastic U channel, and hold the main bus 112 within the panel 102. Each Glastic U shaped support bracket 113 is secured to the main bus 112 with for example, two ¼″×20 screws that are 3 inches long that is a total of six screws for the 3 phases. The bus support members 113 also provide structural support to the different breakers 103 accommodated on the panel 102 and ensure a secure connection thereto. In an embodiment, the main bus 112 is attached to the bus support members 113 via shims 119 as illustrated in FIG. 4E. The shims 119 are configured as ⅛″ thick spacers made, for example, of aluminum. The shims 119 are used for setting the height of the bus bars 112a, 112b, and 112c of the main bus 112. The bus bars 112a, 112b, and 112c of the main bus 112 are positioned 1½″ from the edge of the supporting Z-rails 115 as shown in FIG. 4C. This positioning is accomplished by changing the number of spacers 119 used, which varies depending on the rating of the panel 102 and the number of conductive metal strips/bars 404 are utilized per bus bar per phase. The rating of the panel 102 determines the number of conductive metal strips/bars 404 are utilized per bus bar per phase. For the highest panel rating, where 4 pieces of conductive metal strips/bars 404 are utilized per bus bar per phase, only one spacer 119 is required to achieve the desired positioning, as shown in FIG. 4C. In an embodiment, where only one conductive metal strip/bar 404 is used per bus bar per phase, as shown in FIG. 4G, 7 spacers 119 are required achieve the desired positioning. This setup accommodates for the thickness of 3 pieces of additional ¼″ bus strips/bars, plus one spacer. Similarly, if there are two pieces of conductive metal strip/bar is used per bus bar per phase, 5 spacers 119 are used to achieve the desired positioning. Opposing ends of each of the bus support members 113 are connected to the opposing Z-rails 115 via the support brackets 117 as illustrated in FIGS. 4A-4C. The support brackets 117 are, for example, L-brackets, configured to secure the bus support members 113 to the Z-rails 115. The opposing Z-rails 115 are vertical support rails, which along with the bus support members 113 are configured to provide structural support to the main bus 112. The back stabs 114 implemented in the bus bar assembly 107 feed the main bus 112. In an embodiment, the higher current panel 102 comprises four (4) back stabs 114 instead of 3 back stabs 114 for supporting twin 800 A breakers.

FIG. 4E illustrates an enlarged view of a portion marked A in FIG. 4D. As illustrated in FIG. 4E, each of the bus support members 113 are connected to the main bus 112 using a spacer 119. The spacer 119 is configured to adjust the top of the main bus 112 so that the top of the main bus 112 maintains a constant distance of 1.5″ from the top of the support Z-rails 115, as shown in FIG. 4D. If the panel has less than 4 pieces of conductive metal strips/bars 404 per bus per phase for lower ratings, the number of spacers 119 should be adjusted accordingly. For each missing ¼″ conductive metal strips/bars, two additional ⅛″ spacers 119 are added. For example, if the main bus has 3 pieces of conductive metal strips/bars, 3 spacers 119 will be used. The spacer 119 ensures proper alignment between the main bus 112 and the bus support member 113, facilitating secure and reliable connections between the breakers, switches, etc., within the electrical enclosure 101. This is accomplished by maintaining the distance between the top of Z-rails 115 and the top of the bus consistently 1.5″ for all ratings and different number of phase buses 112 per phase. Consequently, the bus straps remain the same for a given breaker size, regardless of the panel rating and the number of pieces of main bus per phase. Using the same bus straps for a given breaker size will keep the inventory low and optimize the product cost. The spacer 119 also aid in heat dissipation by creating a gap between the main bus 112 and the bus support member 113, allowing air to circulate freely within the modular high-density power distribution panel assembly (MHDPDPA) 100 and naturally cooling the MHDPDPA 100. The spacer 119 also provides flexibility in panel design and installation, allowing for adjustments in the spacing or arrangement of components to accommodate specific requirements or configurations.

FIG. 4F illustrates a front elevation view of the bus bar assembly 107, showing a configuration of the main bus 112 comprising drilled and tapped holes 116.

FIG. 4G illustrates an enlarged back view of a top portion of an embodiment of the bus bar assembly 107 of the modular high-density power distribution panel assembly (MHDPDPA) 100. The bus support members 113 are configured, for example, as horizontal Glastic U shaped support brackets and hold the main bus 112 within the panel 102. Each Glastic U shaped channel 113 is secured to the main bus 112 of each phase with two ¼″×20 screws 401 that are 3 inches long that is a total of six screws for the 3 phases as illustrated in the FIG. 4G. The number of ⅛″ thick spacers 119 used for each phase depends on the number of pieces of conductive metal strips/bars 404 per phase. If there is one piece of conductive metal strip/bar 404 per phase as illustrated in FIG. 4G, 7 spacers 119 are used. FIG. 4H illustrates an enlarged front view of a top portion of an embodiment of the bus bar assembly 107 of the modular high-density power distribution panel assembly (MHDPDPA) 100. If there are three pieces of conductive metal strips/bars 404 per phase, three aluminum spacers 119 are used as illustrated in FIG. 4H. The conductive metal strip/bar 404 of each bus bar, closest to the Glastic U channel 113 has holes that are drilled and tapped to tread ¼″×20 screws 401 through. If there is more than one piece of conductive metal strips/bars 404 per phase, the other pieces of the bus bar are drilled only and not tapped. For example, if there are four pieces of conductive metal strips/bars 404 per phase then one piece of the conductive metal strip/bar 404 closest to the Glastic U channel 113 is drilled and tapped and the remaining three pieces of the bus bar are drilled only so that it is easy to slide them in place as illustrated in FIG. 4H. The other end of the 3 inch long screw 401 is secured with a nut 402 as illustrated in FIG. 4H. It should be noted that four pieces of main bus corresponds to high-density panel rated 6000 A.

In some locations of the main bus 112 where the Glastic U channel 113 is used to support the main bus 113, 3 inch long ¼″×20 screws 401 secure the Glastic U channel 113 and the breaker bus straps 403, shown in FIG. 4I, so no separate screws are required.

FIG. 4I illustrates another enlarged front view of a top portion of an embodiment of the bus bar assembly of the modular high-density power distribution panel assembly (MHDPDPA) 100. The screws 401 securing the Glastic U channel 113 to the main bus 112 also enable securing the bus straps 403 to the main bus 112 for some breakers in the panel 102 as illustrated in FIG. 4I. The bus strap 403 for a particular breaker is placed on top of the main bus 112 and secured with a nut 402 as illustrated in FIG. 4I. The bus straps 403 are insulated with electrical tape or low voltage epoxy, for example Solepoxy, for electrical safety. Due to the wide variation in the panel ratings, type of breakers used, breaker bus strap 403 thickness, number of pieces of main bus, etc., the precise length of the ¼″×20 screw varies significantly. Consequently, there is a need to stock variety of lengths of ¼″×20 screw which will increase both the cost and complexity of the panel build. In order to avoid this, the panel 102 construction always uses only 3″ long ¼″×20 screws 401 to optimize part count and enable ease of manufacturing. After securing the other end of the screw 401 with a nut 402 as illustrated in FIG. 4I, an extra nut 402 is added on top, and the excess screw length is snapped off using a deep 7/16″ socket wrench with a long extension handle. After the screw is cut to the correct length, the extra nut for each connection is removed, and the single nut is torqued to 10+/−1 (9-11) lb-ft and marked with ink for quality control, as illustrated in FIG. 4I. This will ensure that there will be sufficient threads beyond the nut that secures the screw to maintain the required torque, so that the main bus is braced to withstand severe electromagnetic forces that the panel may experience during high short circuit conditions, such as 200 kA.

FIGS. 5A-5D illustrate elevation views of embodiments of the back stabs 114 of the modular high-density power distribution panel assembly (MHDPDPA) 100. In an embodiment, the MHDPDPA 100 implements long back stabs for a 28-inch-deep section or deeper; and short back stabs, for example, about 4 inches to about 6 inches, for a 20-inch-deep section. In an example, the 4-inch short back stabs are made of copper, and the 6-inch back stabs are made of copper. The positioning of the back stabs 114 with respect to the rails 115 in the MHDPDPA 100 are illustrated in FIGS. 5A-5D.

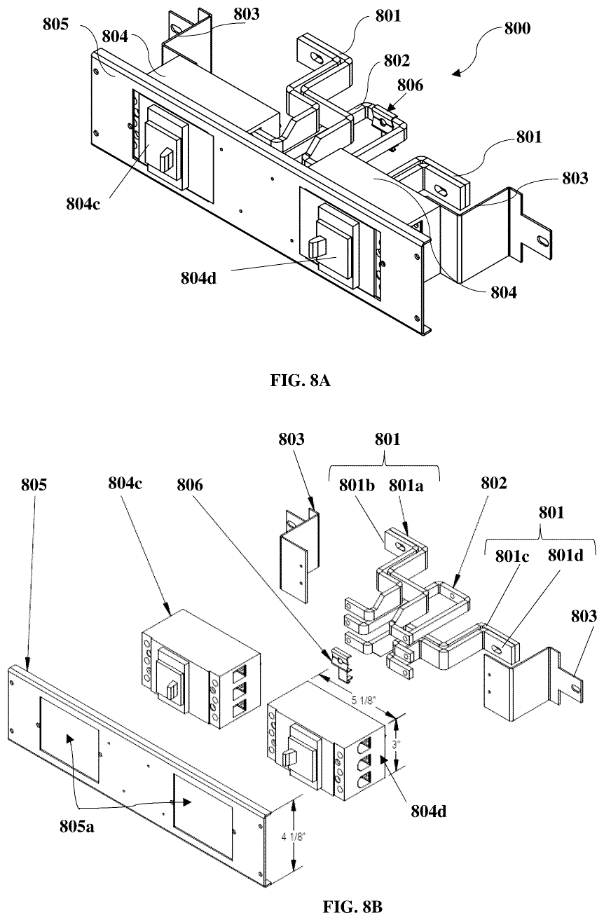

FIG. 6 illustrates size and number guidelines for the back stabs 114 of the modular high-density power distribution panel assembly (MHDPDPA) 100 illustrated in FIGS. 4A-4B, FIG. 4D, and FIGS. 5A-5B.

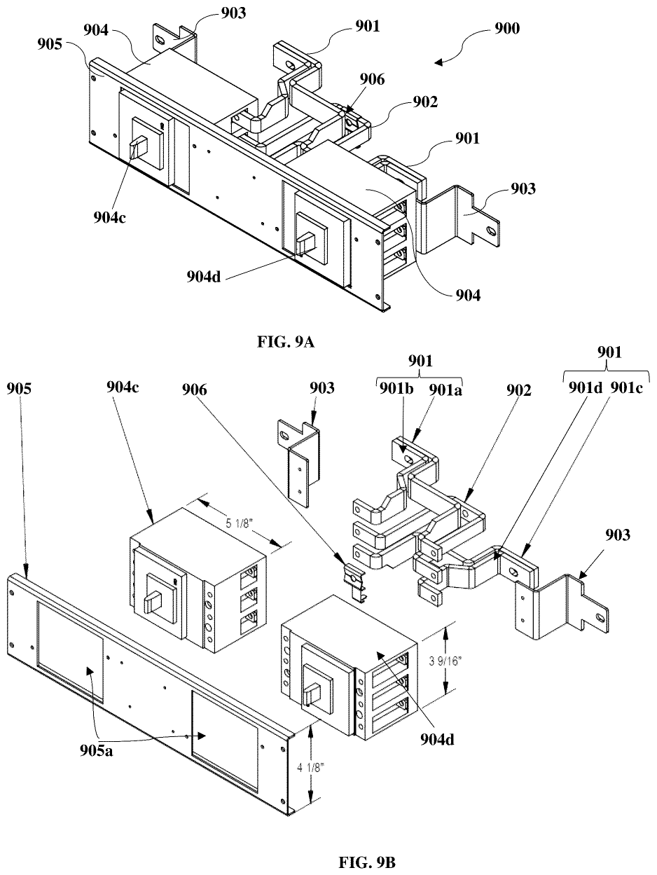

FIG. 7 illustrates tabular representations showing center feed with back stabs panel rating size to back stabs.

FIGS. 8A-8B illustrate perspective, assembled and disassembled views of an embodiment of a bus kit 800 for twin XT1 breakers 804, each with a 125-ampere (125 A) frame, respectively. Although ABB XT breakers are illustrated in FIGS. 8A-8B, FIGS. 9A-9B, FIGS. 10A-10B, FIGS. 11A-11B, FIGS. 12A-12C, FIGS. 13A-13B, FIGS. 14A-14B, FIGS. 15A-15C, and FIGS. 16A-16B, the scope of the modular high-density power distribution panel assembly (MHDPDPA) 100 is not limited to accommodating only ABB XT breakers, but extends to include breakers of other types, for example, Square D™ breakers from Schneider Electric, breakers from Siemens AG, Eaton Corporation, etc., on the panel 102. The MHDPDPA 100 supports both 80%-rated breakers or 100%-rated breakers. When 100%-rated breakers are required, 90° C.-rated cables are used instead of 75° C.-rated cables for breaker output connections. No changes are required to the bus straps to use 100%-rated breakers. Each type of breaker requires its own chassis due to physical differences. The bus straps for each breaker type are different, but perform the same functions.

The bus kit 800 illustrated in FIGS. 8A-8B comprises twin-mountable circuit breakers 804 of one or more types and bus straps 801 and 802. As shown in FIGS. 8A and 8B, bus strap 801 for phase A is a set of a long bus 801a and a short bus 801b. Similarly, bus strap 801 for phase C is a set of a long bus 801c and a short bus 801d. For twin-mounted breakers 804, the short bus strap 801b is connected to A-phase of the left breaker 804c and the long bus strap 801a is connected to C-phase of the right breaker 804d. The long bus strap 801c is connected to C-phase of the left breaker 804c and the short bus strap 801d is connected to A-phase of the right breaker 804d. The bus strap 802 for phase B is connected to B-phase of the left breaker 804c and the right breaker 804d The breaker phasing for the left breaker 804c progresses from top to bottom, while the breaker phasing for the right breaker 804d progresses from bottom to top. Although the circuit breakers 804 shown in FIGS. 8A-8B are ABB XT1 breakers of ABB Ltd., circuit breakers of other brands and manufacturers, for example, Schneider Electric, Eaton, etc., can also be accommodated in the bus kit 800. The frame size of each of the circuit breakers 804 is, for example, up to about 125 A. The height and the length of each of the circuit breakers 804 are, for example, about 3 inches and 5.125 inches, respectively. The bus kit 800 comprises two bus straps 801 for the A-phase and the C-phase and one bus strap 802 for the B-phase. The bus straps 801 and 802 are used for connecting input terminals of the circuit breakers 804 to the main bus 112 illustrated in FIG. 3A. The A-phase and the C-phase bus straps 801 connect the circuit breakers 804 to the bus bars 112a and 112c of the main bus 112, respectively, and the B-phase bus strap 802 connects the circuit breakers 804 to the bus bar 112b of the main bus 112 illustrated in FIG. 3A. The bus kit 800 further comprises a filler plate 805 and brackets 803. The filler plate 805 comprises openings 805a for receiving front faces of the circuit breakers 804. The brackets 803 attach and support the circuit breakers 804 against the filler plate 805. The brackets 803 also attach the bus kit 800 to the panel 102 of the modular high-density power distribution panel assembly (MHDPDPA) 100 as illustrated in FIG. 1A, FIG. 2A, and FIG. 3B. The A-Phase and C-Phase bus straps 801 are offset from the center when they connect to the main bus 112 so they are braced well and do not rotate in the event of a short circuit. Therefore, bus straps 801 do not require an anti-turn clip 806. The B-phase bus strap 802 is centered to the main bus connection (substantially perpendicular) and an anti-turn clip 806 is used as shown in FIG. 8B in order to prevent any rotation during an abnormal event such as a short circuit.

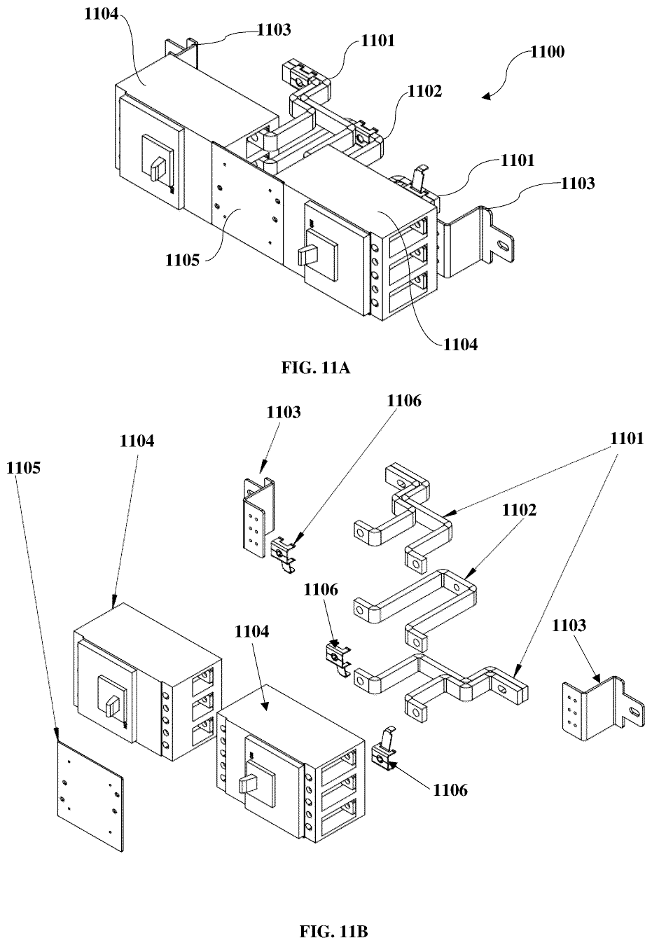

FIGS. 9A-9B illustrate perspective, assembled and disassembled views of an embodiment of a bus kit for twin XT2 breakers 904, each with a 125-ampere (125 A) frame, respectively. The bus kit 900 illustrated in FIGS. 9A-9B comprises twin-mountable circuit breakers 904 of one or more types and bus straps 901 and 902. As shown in FIGS. 9A and 9B, bus strap 901 for phase A is a set of a long bus 901a and a short bus 901b. Similarly, bus strap 901 for phase C is a set of a long bus 901c and a short bus 901d. For twin-mounted breakers 904, the short bus strap 901b is connected to A-phase of the left breaker 904c and the long bus strap 901a is connected to C-phase of the right breaker 904d. The long bus strap 901c is connected to C-phase of the left breaker 904c and the short bus strap 901d is connected to A-phase of the right breaker 904d. The bus strap 902 for phase B is connected to B-phase of the left breaker 904c and the right breaker 904d The breaker phasing for the left breaker 904c progresses from top to bottom, while the breaker phasing for the right breaker 904d progresses from bottom to top. Although the circuit breakers 904 shown in FIGS. 9A-9B are ABB XT2 breakers of ABB Ltd., circuit breakers of other brands and manufacturers, for example, Schneider Electric, Eaton, etc., can also be accommodated in the bus kit 900. The frame size of each of the circuit breakers 904 is, for example, up to about 125 A. The height and the length of each of the circuit breakers 904 are, for example, about 3.5625 inches and 5.125 inches, respectively. The bus kit 900 comprises two bus straps 901 for the A-phase and the C-phase and one bus strap 902 for the B-phase. The bus straps 901 and 902 are used for connecting input terminals of the circuit breakers 904 to the main bus 112 illustrated in FIG. 3A. The A-phase and the C-phase bus straps 901 connect the circuit breakers 904 to the bus bars 112a and 112c of the main bus 112, respectively, and the B-phase bus strap 902 connects the circuit breakers 904 to the bus bar 112b of the main bus 112 illustrated in FIG. 3A. The bus kit 900 further comprises a filler plate 905 and brackets 903. The filler plate 905 comprises openings 905a for receiving front faces of the circuit breakers 904. The brackets 903 attach and support the circuit breakers 904 against the filler plate 905. The brackets 903 also attach the bus kit 900 to the panel 102 of the modular high-density power distribution panel assembly (MHDPDPA) 100 as illustrated in FIG. 1A, FIG. 2A, and FIG. 3B. Both XT1 and XT2 breakers of ABB Ltd., are rated up to 125 A. The XT1 breaker has a basic thermal magnetic trip unit for protection, and the XT2 breaker has advanced electronic trip unit offering more advanced protection capabilities. The size of XT1 and XT2 breakers are different so two separate bus kits are required. Having an option to use both XT1 and XT2 on a panel adds flexibility to the product. The XT1 breaker is typically used for basic protection, while the XT2 breaker is chosen by the customers who require advanced digital protection and communication features. Furthermore, the XT1 breaker is rated for lower interrupting ratings, for example, upto 65 kA at 480V, whereas the XT2 breaker is rated for higher interrupting currents, for example, 100 kA, 150 KA and 200 kA at 480V. For installations located in larger cities and/or urban centers, where high short-circuit currents are more common, the XT2 breakers are the preferred choice for designers. The XT2 breakers also come with advanced electronic trip units with advanced protection and communication features that are critical for data centers, hospitals, banks, telecom facilities, etc. The A-Phase and C-Phase bus straps 901 are offset from the center when they connect to the main bus (not perpendicular) so they are braced well and do not rotate in the event of a short circuit. Therefore, bus straps 901 do not require an anti-turn clip 906. The B-phase bus strap 902 is centered to the main bus connection (substantially perpendicular) and an anti-turn clip 906 is used as shown in FIG. 9B in order to prevent any rotation during an abnormal event such as a short circuit.

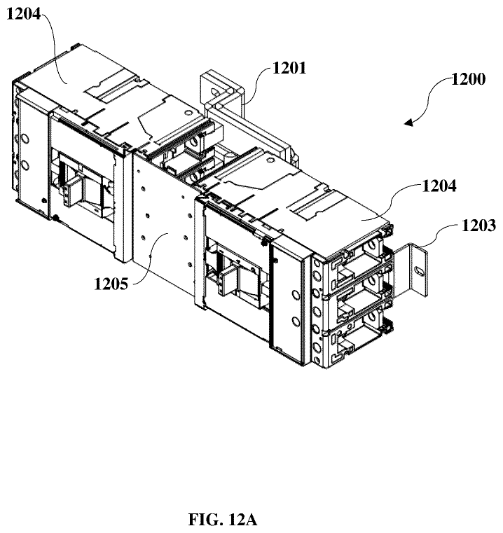

FIGS. 10A-10B illustrate perspective, assembled and disassembled views of an embodiment of a bus kit 1000 for twin XT3 breakers 1004, each with a 225-ampere (225 A) frame, respectively. The bus kit 1000 illustrated in FIGS. 10A-10B comprises twin-mountable circuit breakers 1004 of one or more types and bus straps 1001 and 1002. Although the circuit breakers 1004 shown in FIGS. 10A-10B are ABB XT3 breakers of ABB Ltd., circuit breakers of other brands and manufacturers, for example, Schneider Electric, Eaton, etc., can also be accommodated in the bus kit 1000. The frame size of each of the circuit breakers 1004 is, for example, up to about 250 A. The bus kit 1000 comprises two bus straps 1001 for the A-phase and the C-phase and one bus strap 1002 for the B-phase. The bus straps 1001 and 1002 are used for connecting input terminals of the circuit breakers 1004 to the main bus 112 illustrated in FIG. 3A. The A-phase and the C-phase bus straps 1001 connect the circuit breakers 1004 to the bus bars 112a and 112c of the main bus 112, respectively, and the B-phase bus strap 1002 connects the circuit breakers 1004 to the bus bar 112b of the main bus 112 illustrated in FIG. 3A. The bus kit 1000 further comprises a filler plate 1005 and brackets 1003. The filler plate 1005 is disposed between the two circuit breakers 1004 and attached to front surfaces of the circuit breakers 1004. The brackets 1003 attach and support the circuit breakers 1004 against the filler plate 1005. The brackets 1003 also attach the bus kit 1000 to the panel 102 of the modular high-density power distribution panel assembly (MHDPDPA) 100 as illustrated in FIG. 1A, FIG. 2A, and FIG. 3B. The bus kit 1000 further comprises anti-turn clips 1006, for example, GE anti-turn clips, configured to fit into slots or grooves of the main bus 112 for circuit breakers 1004 and securely connect the circuit breakers 1004 to the panel 102 of the MHDPDPA 100. The circuit breakers 1004 are bolted to the bus bars 112a, 112b, and 112c of the main bus 112 using the bus straps 1001 and 1002 by utilizing the anti-turn clips 1006. The anti-turn clips 1006 exert pressure or friction against the circuit breakers 1004, thereby preventing rotational movement. By preventing the rotational movement, the anti-turn clips 1006 maintain the correct orientation and alignment of the circuit breakers 1004 within the panel 102.

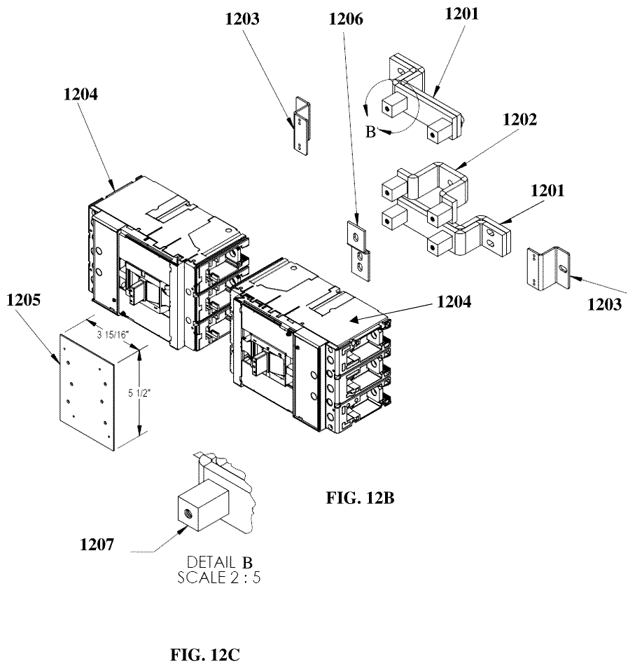

FIGS. 11A-11B illustrate perspective, assembled and disassembled views of an embodiment of a bus kit for twin XT4 breakers, each with a 250-ampere (250 A) frame, respectively. The bus kit 1100 illustrated in FIGS. 11A-11B comprises twin-mountable circuit breakers 1104 of one or more types and bus straps 1101 and 1102. Although the circuit breakers 1104 shown in FIGS. 11A-11B are ABB XT4 breakers of ABB Ltd., circuit breakers of other brands and manufacturers, for example, Schneider Electric, Eaton, etc., can also be accommodated in the bus kit 1100. The frame size of each of the circuit breakers 1104 is, for example, up to about 250 A. The bus kit 1100 comprises two bus straps 1101 for the A-phase and the C-phase and one bus strap 1102 for the B-phase. The bus straps 1101 and 1102 are used for connecting input terminals of the circuit breakers 1104 to the main bus 112 illustrated in FIG. 3A. The A-phase and the C-phase bus straps 1101 connect the circuit breakers 1104 to the bus bars 112a and 112c of the main bus 112, respectively, and the B-phase bus strap 1102 connects the circuit breakers 1104 to the bus bar 112b of the main bus 112 illustrated in FIG. 3A. The bus kit 1100 further comprises a filler plate 1105 and brackets 1103. The filler plate 1105 is disposed between the two circuit breakers 1104 and attached to front surfaces of the circuit breakers 1104. The brackets 1103 attach and support the circuit breakers 1104 against the filler plate 1105. The brackets 1103 also attach the bus kit 1100 to the panel 102 of the modular high-density power distribution panel assembly (MHDPDPA) 100 as illustrated in FIG. 1A, FIG. 2A, and FIG. 3B. The bus kit 1100 further comprises anti-turn clips 1106, for example, GE anti-turn clips, configured to securely connect the circuit breakers 1104 to the panel 102 of the MHDPDPA 100 as disclosed in the description of FIGS. 10A-10B. The XT3 breakers are rated for 225 A, while the XT4 breakers are rated for 250 A. The XT3 breaker has a basic thermal magnetic trip unit for protection, and the XT4 breaker has advanced electronic trip unit with more advanced protection capabilities. Due to their differing sizes, separate bus kits are required for the XT1 and XT2 breakers. Having an option to use both XT3 and XT4 breakers on a panel offers great flexibility to the product. The XT3 breaker with thermal magnetic trip unit is typically used for basic protection, and the XT4 breaker is preferred by the customers who require advanced digital protection and communication features. Furthermore, XT3 breakers are rated for lower interrupting ratings, for example upto 35 kA at 480V, while XT4 breakers are rated for higher interrupting currents, for example 100 kA, 150 kA and 200 kA at 480V. For installations located in larger cities and urban centers, where high short-circuit currents are more common, the XT4 breakers are the preferred choice for designers. The XT4 breakers also come with advanced electronic trip units with advanced protection and communication features that are critical for data centers, hospitals, banks, telecom facilities, etc.

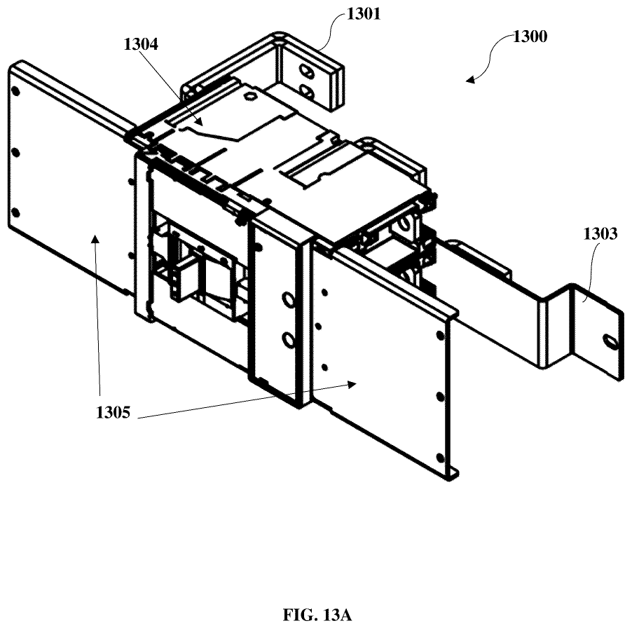

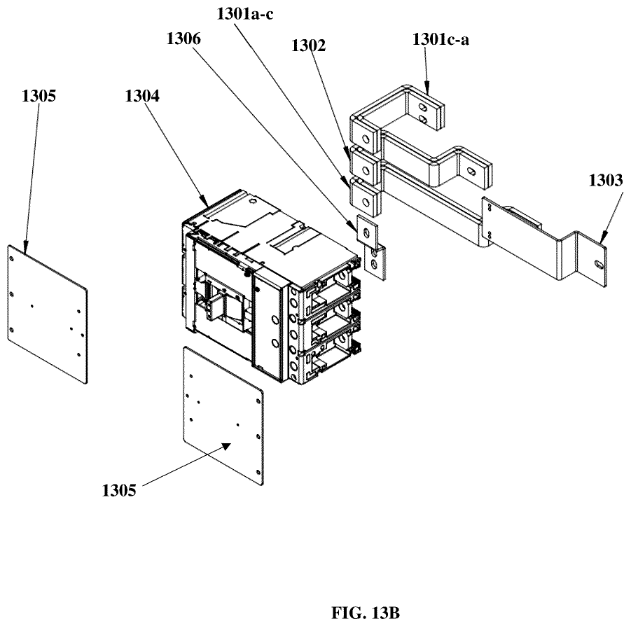

FIGS. 12A-12B illustrate perspective, assembled and disassembled views of an embodiment of a bus kit 1200 for twin XT5 breakers 1204, each with a 400-ampere (400 A) frame, respectively. The bus kit 1200 illustrated in FIGS. 12A-12B comprises twin-mountable circuit breakers 1204 of one or more types and bus straps 1201 and 1202. Although the circuit breakers 1204 shown in FIGS. 12A-12B are ABB XT5 breakers of ABB Ltd., circuit breakers of other brands and manufacturers, for example, Schneider Electric, Eaton, etc., can also be accommodated in the bus kit 1200. The frame size of each of the circuit breakers 1204 is, for example, up to about 400 A. The bus kit 1200 comprises two bus straps 1201 for the A-phase and the C-phase and one bus strap 1202 for the B-phase. The bus straps 1201 and 1202 are used for connecting input terminals of the circuit breakers 1204 to the main bus 112 illustrated in FIG. 3A. The bus straps 1201 and 1202 comprise contact blocks 1207 as disclosed in the description of FIG. 12C. The terminals of the circuit breakers 1204 rest on the contact blocks 1207 and establish electrical connections between the circuit breakers 1204 and the bus straps 1201 and 1202. The A-phase and the C-phase bus straps 1201 connect the circuit breakers 1204 to the bus bars 112a and 112c of the main bus 112, respectively, and the B-phase bus strap 1202 connects the circuit breakers 1204 to the bus bar 112b of the main bus 112 illustrated in FIG. 3A. The bus kit 1200 further comprises a filler plate 1205 and brackets 1203. The filler plate 1205 is disposed between the two circuit breakers 1204 and attached to front surfaces of the circuit breakers 1204. The width and the height of the filler plate 1205 are, for example, about 3.9375 inches and about 5.5 inches, respectively. The brackets 1203 attach and support the circuit breakers 1204 against the filler plate 1205. The brackets 1203 also attach the bus kit 1200 to the panel 102 of the modular high-density power distribution panel assembly (MHDPDPA) 100 as illustrated in FIG. 1A, FIG. 2A, and FIG. 3B. The bus kit 1200 further comprises an anti-turn bus bracket 1206 configured to securely connect the circuit breakers 1204 to the panel 102 of the MHDPDPA 100.

FIG. 12C illustrates an enlarged view of a portion marked B in FIG. 12B. The enlarged view in FIG. 12C illustrates one of the contact blocks 1207 of the bus straps 1201 and 1202 illustrated in FIGS. 12A-12B. The contact blocks 1207 refer to points where electrical contacts are made between the bus straps 1201 and 1202 and the circuit breakers 1204 illustrated in FIGS. 12A-12B. The contact blocks 1207 are configured to provide a secure connection while allowing for easy installation and maintenance of the circuit breakers 1204.

FIGS. 13A-13B illustrate perspective, assembled and disassembled views of an embodiment of a bus kit 1300 for a XT5 breaker 1304 with an 600-ampere (600 A) frame, respectively. In this case each phase bus is two pieces of bus and a set would be a two-piece long bus 1301a-c and a two-piece short bus 1301c-a. The A-Phase bus strap and C-phase bus straps are different (one is longer than the other). For single mounted circuit breaker, A-phase and C-phase bus straps are interchangeable depending on the output lugs of the breaker. If the single mounted circuit breaker 1304 is configured or mounted such that its output is to the right, then A-phase 1301a-c & C-phase bus 1301c-a of this configuration/mounting of the single mounted circuit breaker 1304 become C-phase 1301c-a and A-Phase bus 1301a-c when the output of the single mounted circuit breaker 1304 is to the left of the of the single mounted circuit breaker 1304. The B-bus phase uses a different bus strap 1302 as illustrated in FIGS. 13A-13B. The bus kit 1300 illustrated in FIGS. 13A-13B comprises a single-mountable circuit breaker 1304 of one or more types and bus straps 1301 and 1302. Although the circuit breaker 1304 shown in FIGS. 13A-13B is an ABB XT5 breaker of ABB Ltd., a circuit breaker of another brand and manufacturer, for example, Schneider Electric, Eaton, etc., can also be accommodated in the bus kit 1300. The frame size of the circuit breaker 1304 is, for example, up to about 600 A. The bus kit 1300 comprises two bus straps 1301 for the A-phase and the C-phase and one bus strap 1302 for the B-phase. The bus straps 1301 and 1302 are used for connecting input terminals of the circuit breaker 1304 to the main bus 112 illustrated in FIG. 3A. The terminals of the circuit breaker 1304 establish electrical connections between the circuit breaker 1304 and the bus straps 1301 and 1302. The A-phase and the C-phase bus straps 1301 connect the circuit breaker 1304 to the bus bars 112a and 112c of the main bus 112, respectively, and the B-phase bus strap 1302 connects the circuit breaker 1304 to the bus bar 112b of the main bus 112 illustrated in FIG. 3A. The bus kit 1300 further comprises filler plates 1305, brackets 1303, and anti-turn bus bracket 1306. The anti-turn bus bracket 1306 is configured to securely connect the circuit breakers 1304 to the panel 102 of the MHDPDPA 100. The anti-turn bus bracket 1306 prevents rotation of the bus strap 1301 in the event of an abnormal condition such as a short circuit. The filler plates 1305 are attached to opposing ends of the circuit breaker 1304. The height of each of the filler plates 1305 is, for example, about 8.25 inches. The brackets 1303 attach and support the circuit breakers 1304 against the filler plates 1305. The brackets 1303 also attach the bus kit 1300 to the panel 102 of the modular high-density power distribution panel assembly (MHDPDPA) 100 as illustrated in FIG. 1A, FIG. 2A, and FIG. 3B.

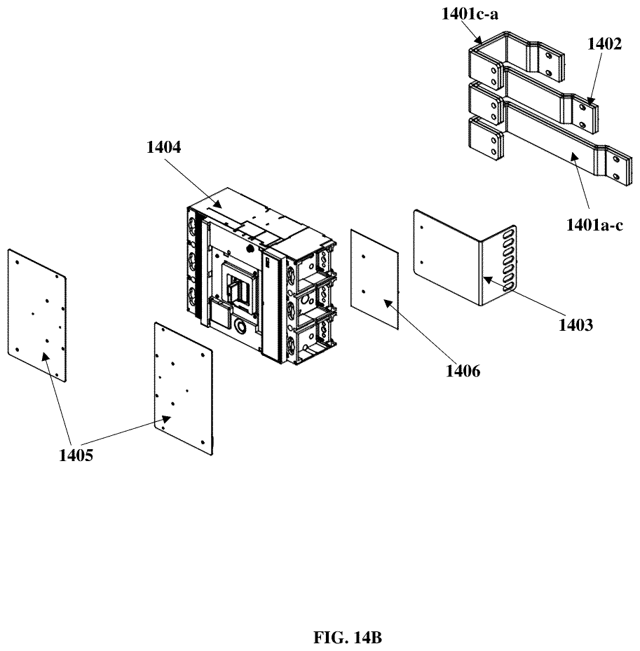

FIGS. 14A-14B illustrate perspective, assembled and disassembled views of an embodiment of a bus kit 1400 for a XT6 breaker 1404 with an 800-ampere (800 A) frame, respectively. In this case each phase bus is two pieces of bus and a set would be a two-piece long bus 1401a-c and a two-piece short bus 1401c-a. The A-Phase bus strap and C-phase bus straps are different (one is longer than the other). For single mounted circuit breaker, A-phase and C-phase bus straps are interchangeable depending on the output lugs of the breaker. If the single mounted circuit breaker 1404 is configured or mounted such that its output is to the right, then A-phase 1401a-c & C-phase bus 1401c-a of this configuration/mounting of the single mounted circuit breaker 1404 become C-phase 1401c-a and A-Phase bus 1401a-c when the output of the single mounted circuit breaker 1404 is to the left of the of the single mounted circuit breaker 1404. The B-bus phase uses a different bus strap 1402 as illustrated in FIGS. 14A-14B. The bus kit 1400 illustrated in FIGS. 14A-14B comprises a single-mountable circuit breaker 1404 of one or more types and bus straps 1401 and 1402. Although the circuit breaker 1404 shown in FIGS. 14A-14B is an ABB XT6 breaker of ABB Ltd., a circuit breaker of another brand and manufacturer, for example, Schneider Electric, Eaton, etc., can also be accommodated in the bus kit 1400. The frame size of the circuit breaker 1404 is, for example, up to about 800 A. The bus kit 1400 comprises two bus straps 1401 for the A-phase and the C-phase and one bus strap 1402 for the B-phase. The bus straps 1401 and 1402 are used for connecting input terminals of the circuit breaker 1404 to the main bus 112 illustrated in FIG. 3A. The terminals of the circuit breaker 1404 establish electrical connections between the circuit breaker 1404 and the bus straps 1401 and 1402. The A-phase and the C-phase bus straps 1401 connect the circuit breaker 1404 to the bus bars 112a and 112c of the main bus 112, respectively, and the B-phase bus strap 1402 connects the circuit breaker 1404 to the bus bar 112b of the main bus 112 illustrated in FIG. 3A. The bus kit 1400 further comprises filler plates 1405 and brackets 1403. The filler plates 1405 are attached to opposing ends of the circuit breaker 1404. The height of each of the filler plates 1405 is, for example, about 8.25 inches. The filler plate 1405, as illustrated in FIG. 14B, is attached to front surfaces of the circuit breakers 1404 using small pointed screws of plastic #6 size, ⅝″ long (not shown). The brackets 1403 attach and support the circuit breakers 1404 against the filler plates 1405. The brackets 1403 also attach the bus kit 1400 to the panel 102 of the modular high-density power distribution panel assembly (MHDPDPA) 100 as illustrated in FIG. 1A, FIG. 2A, and FIG. 3B. The bus kit 1400 further comprises a barrier 1406, for example, a Glastic barrier, configured to provide insulation and mechanical support within the bus kit 1400. Furthermore, B-phase bus strap 1402 is secured by two bolts (not shown) to the main bus 112 so an anti-turn bus piece is not required.

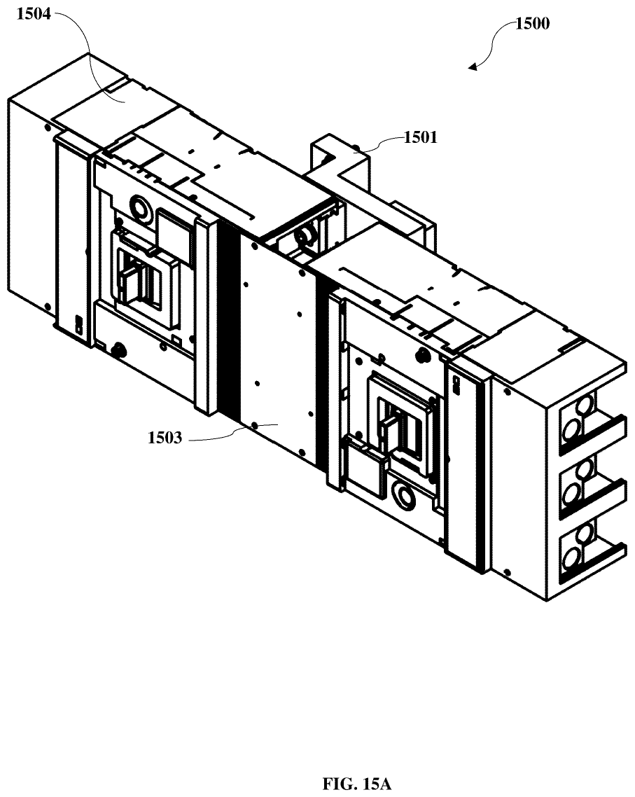

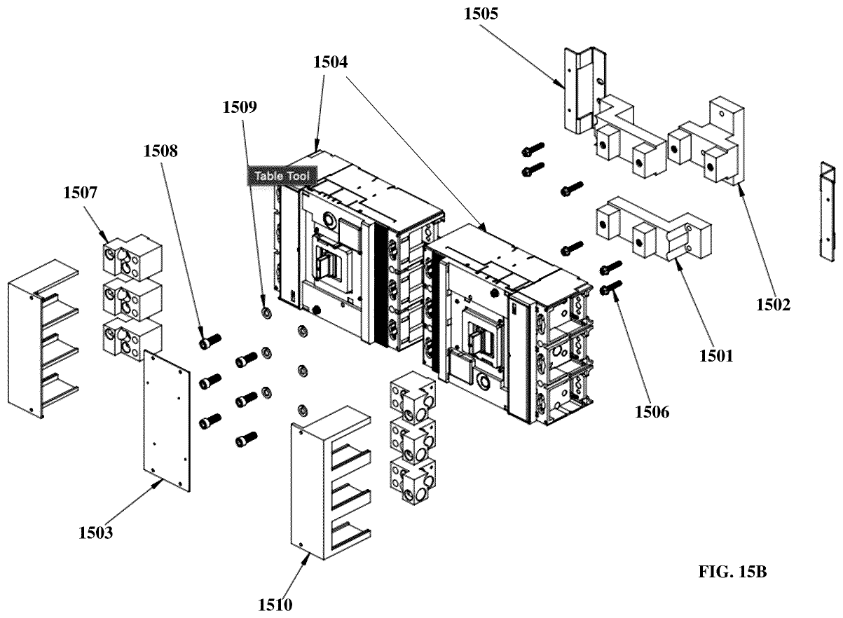

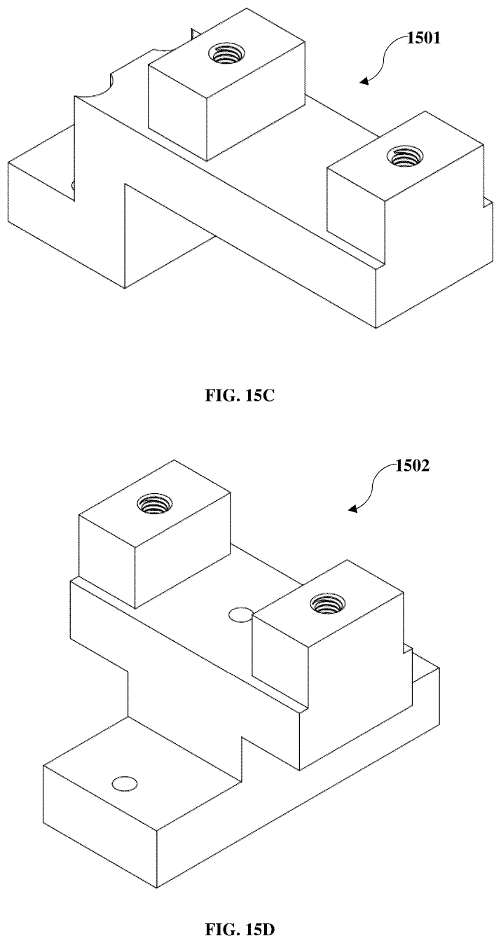

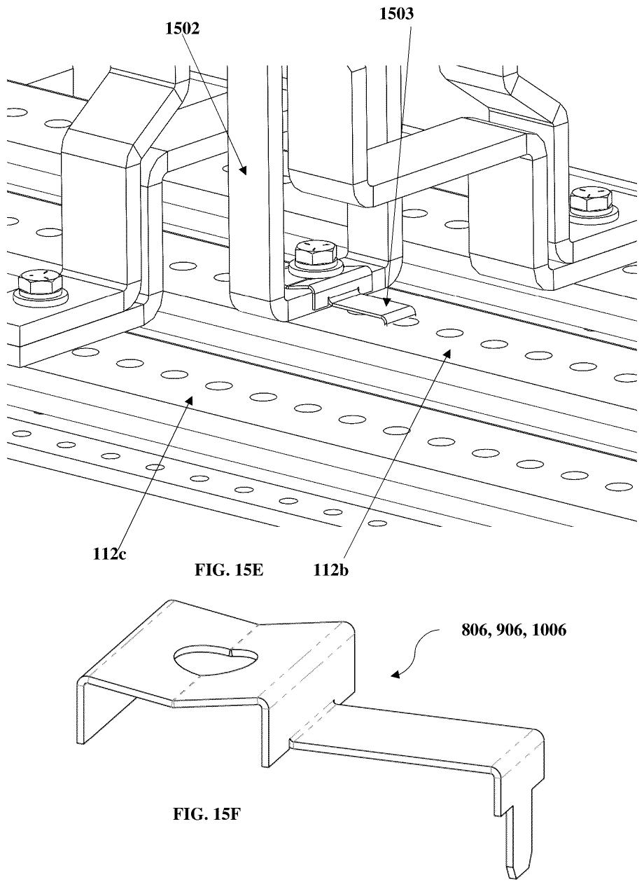

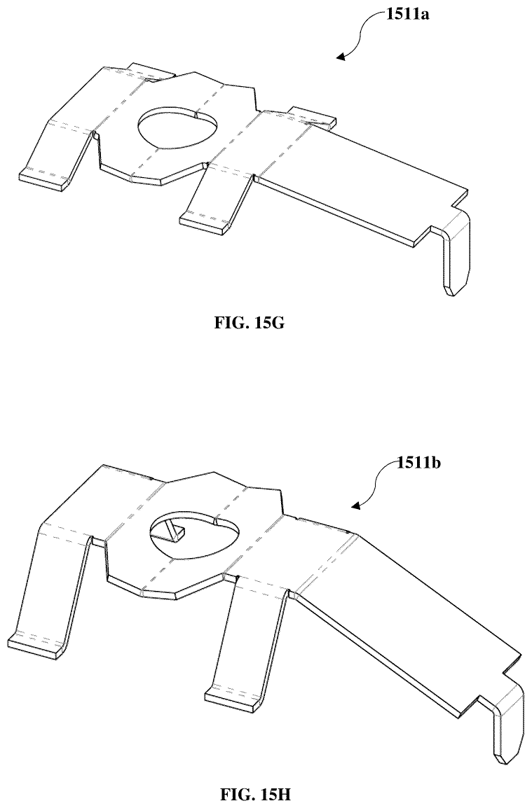

FIGS. 15A-15B illustrate perspective, assembled and disassembled views of an embodiment of a bus kit 1500 for twin XT6 breakers 1504, each with a 800-ampere (800 A) frame, respectively. The bus kit 1500 illustrated in FIGS. 15A-15B comprises twin-mountable circuit breakers 1504 of one or more types and bus straps 1501 and 1502. Although the circuit breakers 1504 shown in FIGS. 15A-15B are ABB XT6 breakers of ABB Ltd., circuit breakers of other brands and manufacturers, for example, Schneider Electric, Eaton, etc., can also be accommodated in the bus kit 1500. The frame size of each of the circuit breakers 1504 is, for example, up to about 600 A to 800 A. The bus kit 1500 comprises two bus straps 1501 for the A-phase and the C-phase and one bus strap 1502 for the B-phase. The bus straps 1501 and 1502 are used for connecting input terminals of the circuit breakers 1504 to the main bus 112 illustrated in FIG. 3A. The bus straps 1501 and 1502 are connected to the main bus 112 using screws 1506. The terminals of the circuit breakers 1504 establish electrical connections between the circuit breakers 1504 and the bus straps 1501 and 1502. The A-phase and the C-phase bus straps 1501 connect the circuit breakers 1504 to the bus bars 112a and 112c of the main bus 112, respectively, and the B-phase bus strap 1502 connects the circuit breakers 1504 to the bus bar 112b of the main bus 112 illustrated in FIG. 3A. The bus kit 1500 further comprises a filler plate 1503. The filler plate 1503 is disposed between the two circuit breakers 1504 and attached to front surfaces of the circuit breakers 1504 using small pointed screws of plastic #6 size, ⅝″ long (not shown), as illustrated in FIG. 15B. Lugs 1507 are used for cable connections within the enclosure 101, and are secured to the circuit breaker with screws (not shown) that are part of the circuit breaker lug kit. Screws 1508 and washers 1509 are used to secure the bus straps to the circuit breakers 1504, and the brackets 1510 are used to securely cover the lugs 1507 to make the connection touch safe. The width and the height of the filler plate 1305 are, for example, about 3.82 inches and about 8.25 inches, respectively. The brackets 1505 attach the bus kit 1500 to the panel 102 of the modular high-density power distribution panel assembly (MHDPDPA) 100 as illustrated in FIG. 1A, FIG. 2A, and FIG. 3B. Furthermore, twin 600 A and twin 800 A breakers both use this bus assembly for both 80% and 100% applications. This will keep the number of bus kit parts optimized.

FIGS. 15C-15D illustrate perspective views of an embodiment of an A-phase/C-phase bus strap 1501 and a B-phase bus strap 1502 of the modular high-density power distribution panel assembly (MHDPDPA) 100, respectively. Twin 800 A breakers require bigger bus straps 1501 and 1502 to support higher current density in a smaller area. The A-bus phase and the C-bus phase for 800 A breakers use the same bus straps 1501 and the B-bus phase requires a different bus strap 1502 as illustrated in FIGS. 15A-15B.

The anti-turn clips 806, 906, 1006, and 1106, shown in FIGS. 8B, 9B, 10B, 11B, are used if the breaker bus strap for A, B, and C Phases is secured with a single bolt as shown in FIG. 15E which illustrates the B-phase bus of XT4. If the bus strap is secured using two bolts (FIGS. 14A-14B, for example) or if the bus strap is offset with respect to the main bus (as exemplarily illustrated in FIGS. 8A, 8B, 9 A and 9B for A and C phases), then anti-turn clip is not necessary. Variety of anti-turn clips 806, 906, 1006, 1106, 1511a, and 1511b are used to secure the bus straps as shown in FIGS. 15F, 15G, 15H, and 15I. The anti-turn clips are shown in corresponding bus kits (XT1, XT2, XT3, and XT4) while a special anti-turn bus piece is used for XT5-anti-turn bus bracket 1306. This paragraph highlights the proper bracing of bus straps during abnormal events such as short circuits. For higher currents (600 A and up), typically two bolts are used to secure bus straps to the main bus so anti-turn clip or bracket is not required.

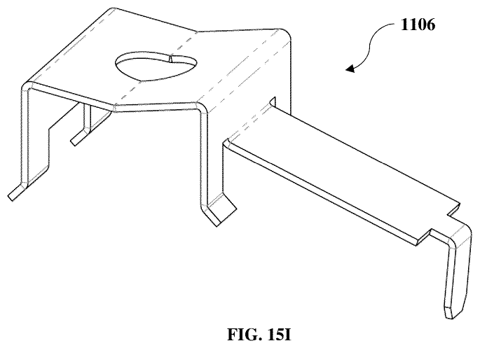

FIGS. 16A-16B illustrate perspective, assembled and disassembled views of an embodiment of a bus kit 1600 for a XT7 breaker 1604 with a 1200-ampere (1200 A) frame, respectively. The bus kit 1600 illustrated in FIGS. 16A-16B comprises a single-mountable circuit breaker 1604 of one or more types and bus straps 1601 and 1602. Although the circuit breaker 1604 shown in FIGS. 16A-16B is an ABB XT7 breaker of ABB Ltd., a circuit breaker of another brand and manufacturer, for example, Schneider Electric, Eaton, etc., can also be accommodated in the bus kit 1600. The frame size of the circuit breaker 1604 is, for example, up to about 1200 A. The bus kit 1600 comprises two bus straps 1601 and 1606 for the A-phase and the C-phase, respectively, and one bus strap 1602 for the B-phase. The bus straps 1601, 1602, and 1606 are used for connecting input terminals of the circuit breaker 1604 to the main bus 112 illustrated in FIG. 3A. The A-phase and the C-phase bus straps 1601 and 1606 connect the circuit breaker 1604 to the bus bars 112a and 112c of the main bus 112, respectively, and the B-phase bus strap 1602 connects the circuit breaker 1604 to the bus bar 112b of the main bus 112 illustrated in FIG. 3A. The bus kit 1600 further comprises filler plates 1605, brackets 1603 and 1610, and barriers 1607 and 1609. The filler plates 1605 are attached to opposing ends of the circuit breaker 1604. The brackets 1603 and 1610 attach and support the circuit breakers 1604 against the filler plates 1605. The bracket 1603 attaches the bus kit 1600 to the panel 102 of the modular high-density power distribution panel assembly (MHDPDPA) 100 as illustrated in FIG. 1A, FIG. 2A, and FIG. 3B. The bracket 1610 is a filler bracket, for example, a Z-bracket. The barrier 1607 is fastened to the bus strap 1606 using screws 1608, for example, nylon hex head screws. The barrier 1609 is, for example, a Glastic barrier, configured to provide insulation and mechanical support within the bus kit 1600.

The modular high-density power distribution panel assembly (MHDPDPA) 100 disclosed herein is configured to have a substantially high rating of, for example, about 6000 A; a compact footprint; highest current density per row, for example, 2×800 A or 1600 A; a wide range of distribution breakers rated, for example, from about 100 A to about 1200 A; an 80% rating or a 100% rating on all distribution breakers; a 100 A to 800 A or twin-mount, and a 600 A, 800 A, 1000 A and 1200 A single-mount design; a switchboard construction, tested to ANSI, UL, CSA, NFPA70, and NEC standards; mains lugs for cables or bus-connections to a switchboard; and a standalone panel or a part of a switchboard lineup.

The modular high-density power distribution panel assembly (MHDPDPA) 100 disclosed herein is configured with a substantial current density to meet the needs of power-hungry data centers and reduce its footprint within these data centers. The MHDPDPA 100 allows a flexible implementation of different current ratings. For example, the MHDPDPA 100 is rated at high currents, for example, about 6000 amperes (A), to interface with low voltage switchgears that are rated at 6000 A. The MHDPDPA 100 further accommodates multiple breakers of different brands in a single modular power distribution panel for supply chain applications. Moreover, the MHDPDPA 100 is a naturally cooled power distribution panel free of cooling systems. Furthermore, the MHDPDPA 100 is tested to a substantially high short circuit rating of, for example, about 200 kiloamperes at 480V AC, thereby increasing safety in big cities and other large metro areas where the available short circuit current is substantially high.

The modular high-density power distribution panel assembly (MHDPDPA) 100 disclosed herein is rated at high currents, for example, about 6000 A, to interface with a low voltage switchgear that is rated at 6000 A to meet the ever-growing power demand for data center and other industrial applications. The MHDPDPA 100 has a substantially high current density, thereby allowing minimization of the footprint of the MHDPDPA 100. The design of the MHDPDPA 100 with a high current rating and the highest current density possible allows for a naturally cooled panel requiring no cooling equipment, for example, fans, liquid cooling, etc. The design of the MHDPDPA 100 incorporates multiple available breakers of different types in sizes that range, for example, from 100 A through 1200 A. The MHDPDPA 100 also incorporates both 80%-rated and 100%-rated designs, in either a standalone panel or a panel that is bus connectable to a low voltage switchgear. The 100% rated loads will require 90° C. rated cables instead of 75° C. rated cables. This is not a significant disadvantage, as high density data center installations typically use 90° C. rated cables as standard practice. The MHDPDPA 100 is flexible with respect to how the different current ratings are arranged in the panel 102. The MHDPDPA 100 accommodates breakers of multiple brands for supply chain applications. For ease of assembly, protection coordination of breakers, and short-circuit series rating benefits, all breakers in a given panel are sourced from the same manufacturer. Using a single type of breaker in any given panel also makes the mechanical hardware and bus kits easy to design and build. Form both an application and field perspective, using breakers form one manufacturer in a given panel makes field installation and maintenance much easier. For breakers with advanced electronic trip units, using a single type of breakers in a given panel will enable effective communication of operation of the breaker to the central building management system. The MHDPDPA 100 provides the highest load current per row of breakers. The MHDPDPA 100 is tested, for example, up to about a 200 kA short circuit rating as per Underwriters Laboratories (UL) standards. The MHDPDPA 100 meets the stringent demands of flexible power distribution architectures and custom power distribution solutions for data center and other critical applications.

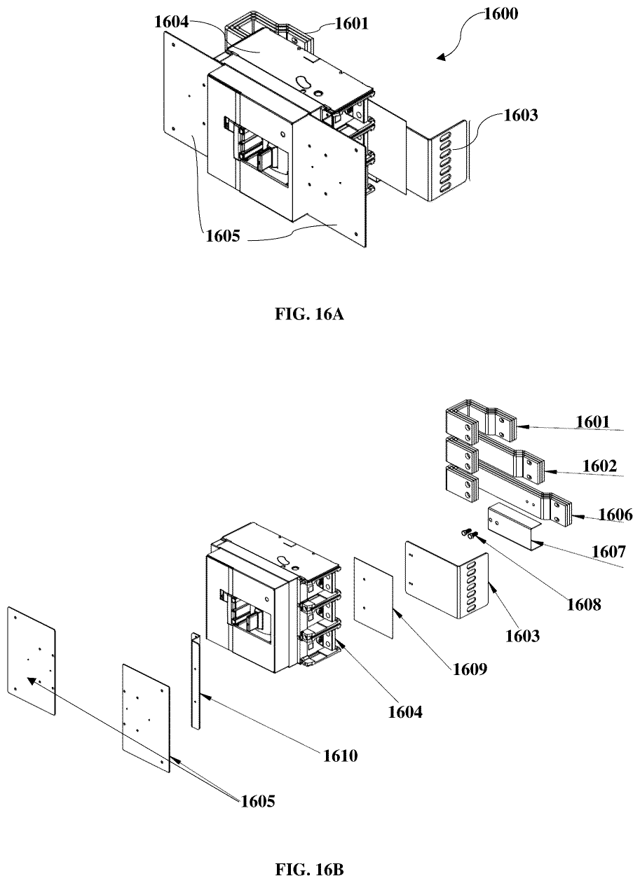

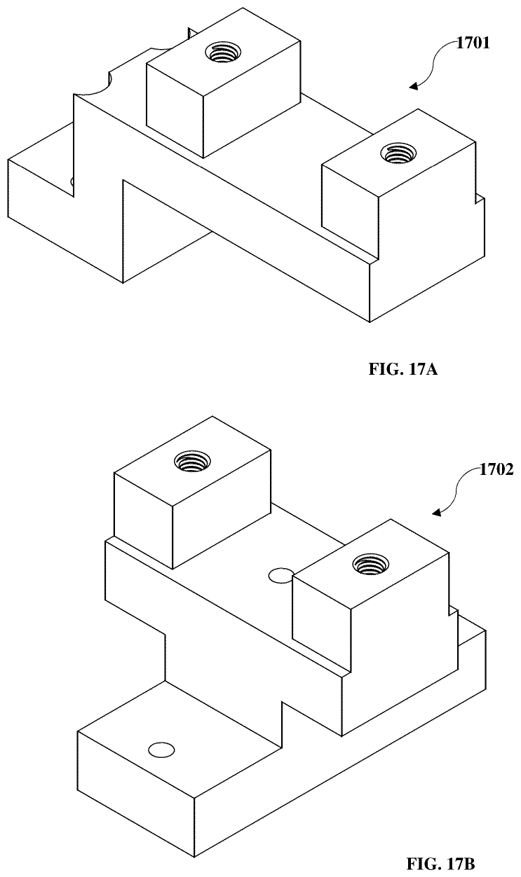

The physical size of circuit breakers impose certain limitations on their integration into the modular high-density power distribution panel assembly (MHDPDPA) 100. The circuit breakers vary in size, so there are certain limitations due to the circuit breaker length. The circuit breakers from manufacturers such as ABB and Square D (Schneider) are compact, with height of about 8.5 inches and a length of about 12 inches. As used herein, height refers to the width of the circuit breaker since the circuit breaker is rotated 90 degrees when installed in a panel, for example, the MHDPDPA 100. Likewise, length refers to the height of the circuit breaker since the circuit breaker is rotated 90 degrees when installed in the panel. These dimensions allow ABB and Square D circuit breakers to be twin mounted with 100% rating, which gives a high density of 1600 A per row of the MHDPDPA 100. However, due to physical differences and varying terminal locations between circuit breaker models, the bus kit must be customized for each circuit breaker. FIGS. 17A-17B illustrates a perspective view of an embodiment of the bus strap 1701 and 1702 for twin ABB 800 A XT6 breakers. The bus strap 1703 and 1704 for Square D twin 800 A circuit breakers is illustrated in FIGS. 17C-17D. These bus strap parts for both ABB and Square D breakers are rated for both 80% and 100% rating, respectively.

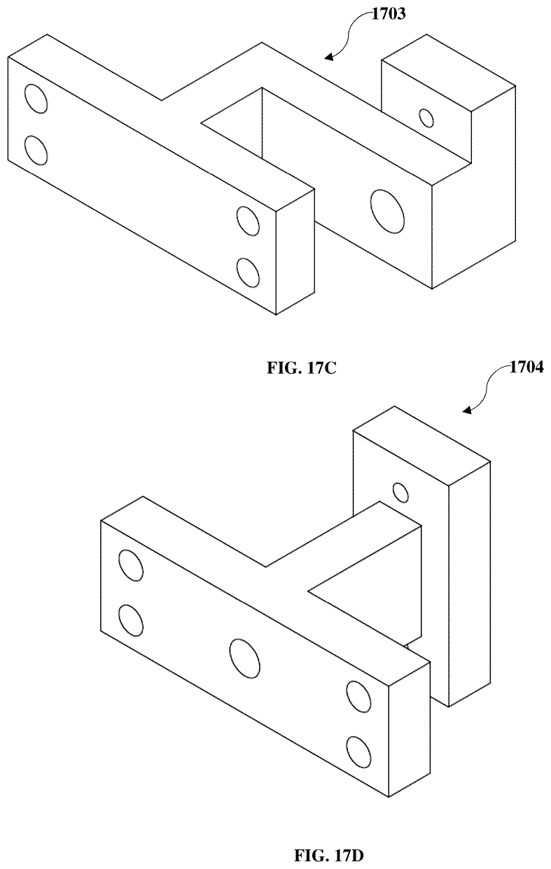

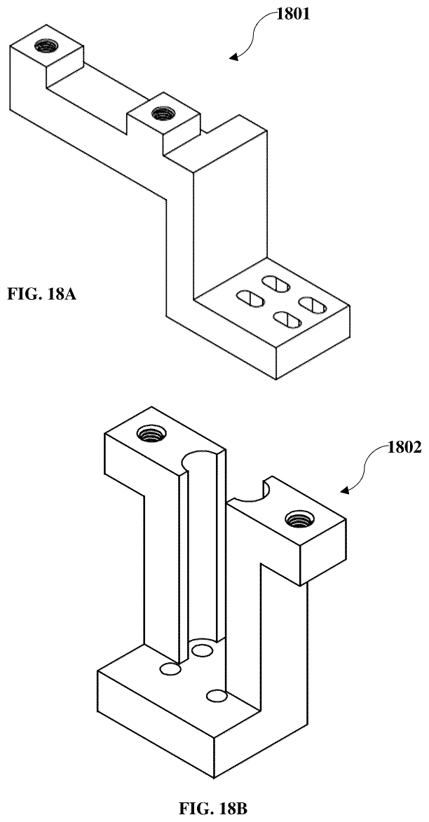

Furthermore, the 800 A circuit breakers from manufacturers such as Eaton and Siemens, have a length of about 16 inches. As used herein, length refers to the height of the circuit breaker since the circuit breaker is rotated 90 degrees when installed in the panel, for example, the MHDPDPA 100. Although, it is possible to design twin 800 A bus straps for Eaton and Siemens breakers, the overall width of the high-density panel will become too big for the panel to be practical. The existing width of the high-density panel is about 52 inches, and accommodating twin 800 A Eaton or Siemens breakers would require a panel width of at least 60 inches, which is not desirable. Consequently, the maximum breaker rating that can be used in the high-density panel for twin mounted Eaton and Siemens breakers is 600 A. Single 800 A, 1000 A, and 1200 A breakers from Eaton and Siemens can still be used effectively, as they do not require additional panel width. FIGS. 18A-18B illustrates a perspective view of an embodiment of the bus strap 1801 and 1802 for twin 600 A Eaton breakers. FIGS. 18C-18D illustrates a perspective view of an embodiment of the bust strap 1803 and 1804 for twin 600 A for Siemens breakers. Both of these bus straps are suitable for both 80% and 100% rated loads. For safety, all the bus straps are insulated with electrical tape or epoxy insulation, although the insulation is not depicted in the figures.

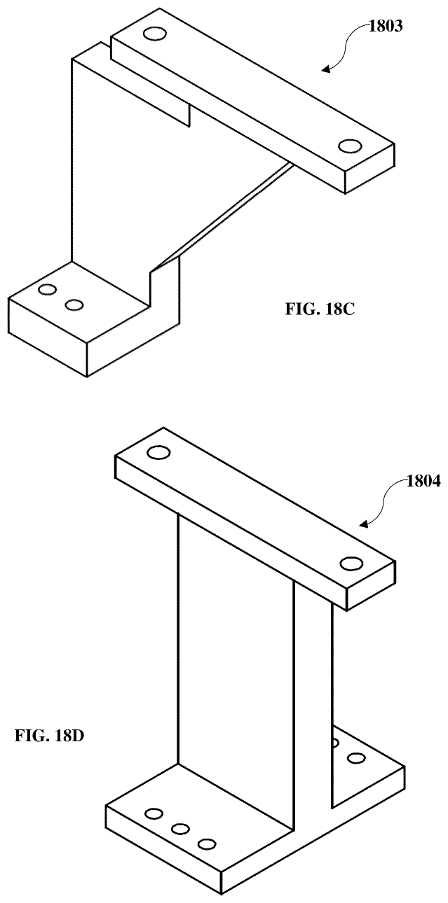

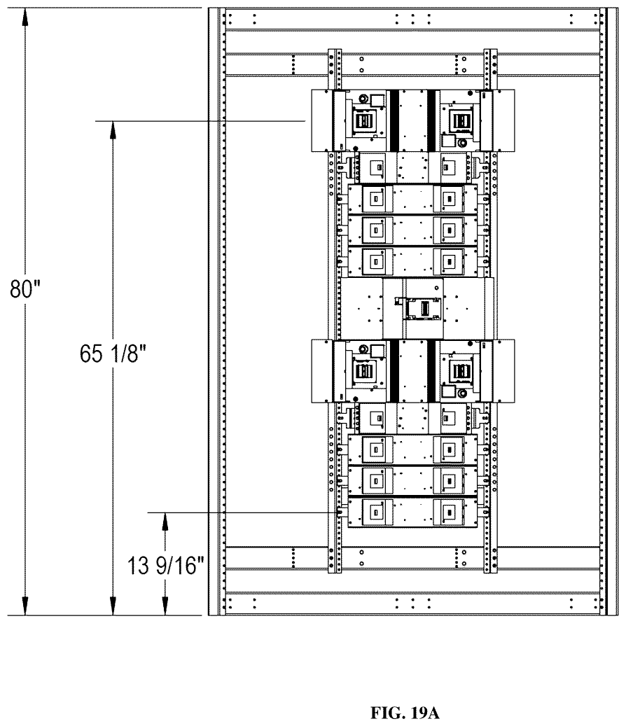

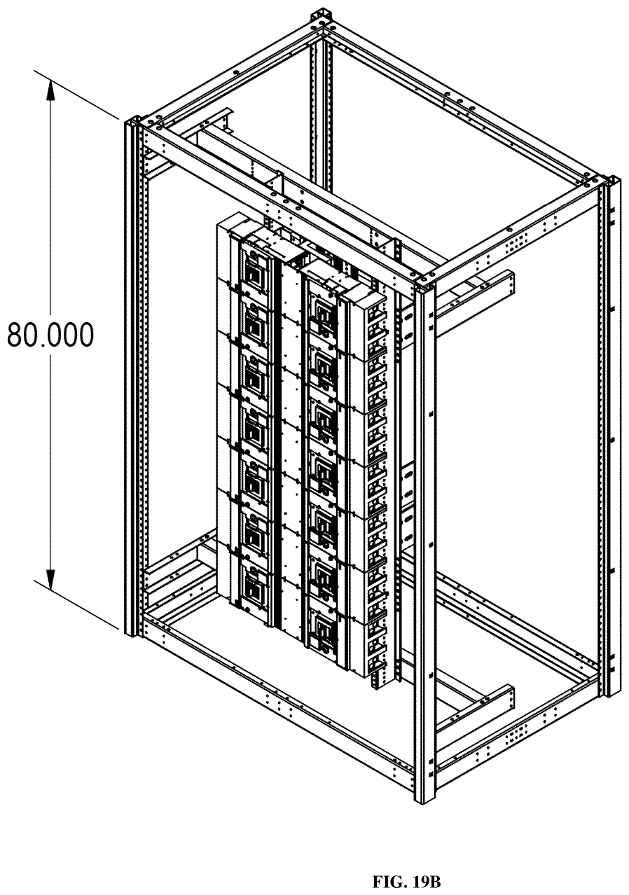

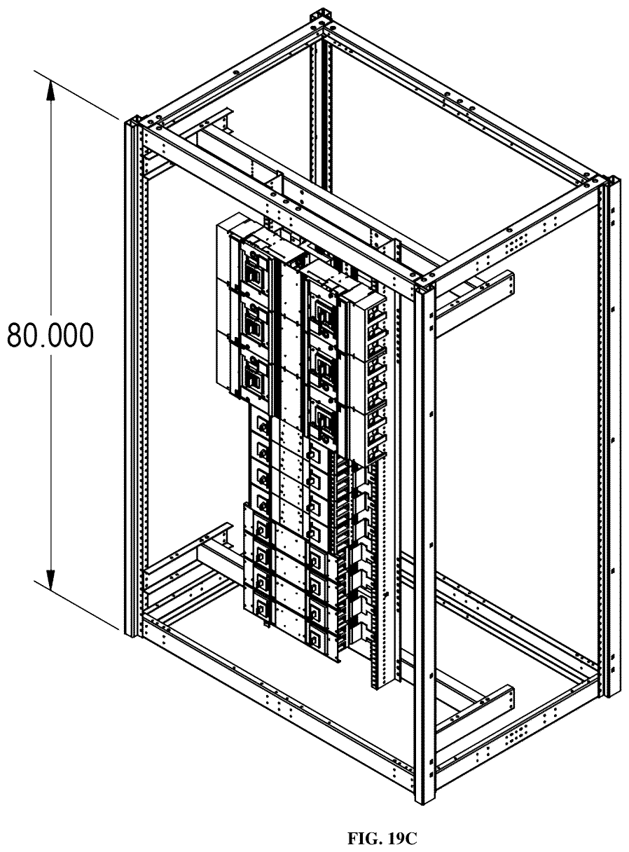

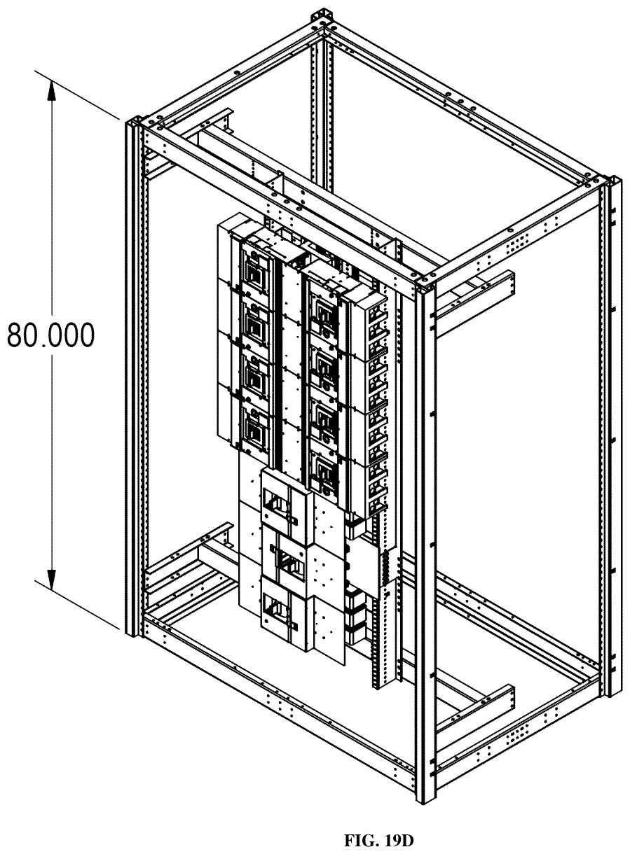

The 6000 A rated modular high-density power distribution panel assembly (MHDPDPA) 100 typically has a height of 91.5″, which matches the typical height of the switchgear to which the panel is normally bus connected to form the electrical distribution switchgear. However, is also possible to design and build a 6000 A MHDPDPA with an 80 inches height. FIG. 19A illustrates a front view of an embodiment of a MHDPDPA with an 80″ height. The flexibility in panel design allows for the use of breakers with different ratings, depending on customer requirements. FIGS. 19B-19E illustrate various breakers combinations in a high-density, 600 A panel that is 80″ high. FIG. 19B a front view of an embodiment of a MHDPDPA with 14×800 A XT6 breakers. FIG. 19C a front view of an embodiment of a MHDPDPA with 6×800 A XT6 breakers+8×250 A XT4 breakers+8×125 A XT2 breakers. FIG. 19D a front view of an embodiment of a MHDPDPA with 8×800 A XT6 breakers+3×1200 A XT7 breakers. FIG. 19E a front view of an embodiment of a MHDPDPA with 5×1200 A XT7 breakers+6×400 A XT4 breakers. These examples demonstrate a few of the possible breaker combinations. However, the MHDPDPA is very flexible and can accommodate any required combinations of breakers subject to the bus height, and with twin breakers limited to a maximum rating of 800 A, and single breakers rated 1000 A and 1200 A. The 6000 A rating MHDPDPA can be built with 91.5″ high or 80″ height structure. Both height structures may use the same size and number of slots 104a, 104b, and 104c for ventilation. However, an 80″ high panel is more compact and has more power density per unit volume of the overall panel enclosure. Additionally, the 80″ high panel has more room on the top of the panel for running cable trays or conduits on the top of the panel without significantly increasing the overall installation height requirements.

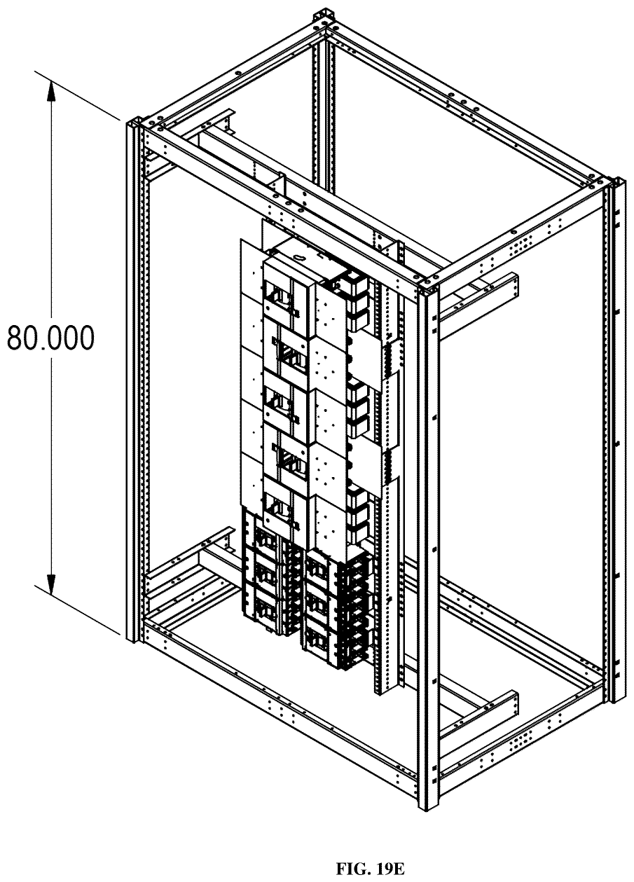

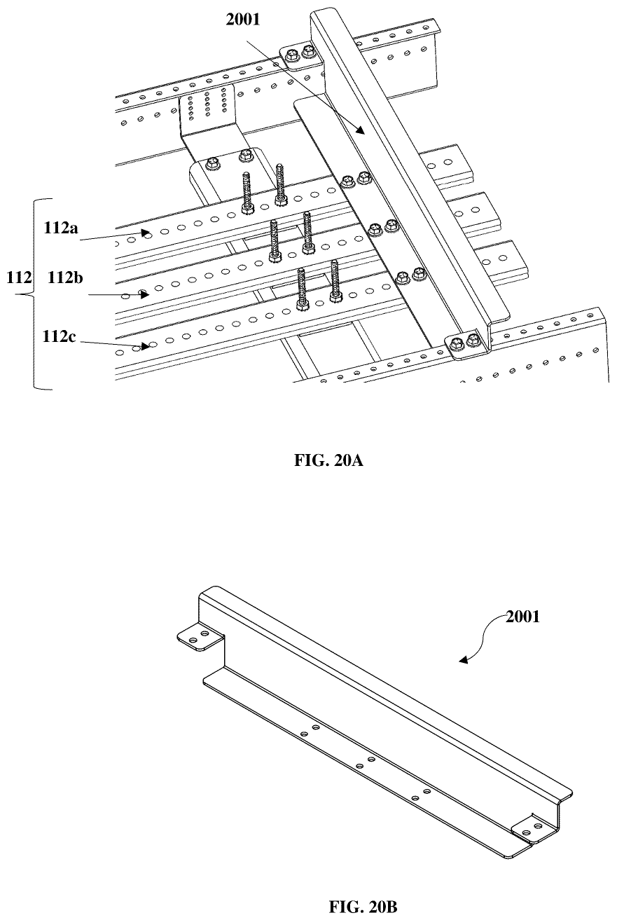

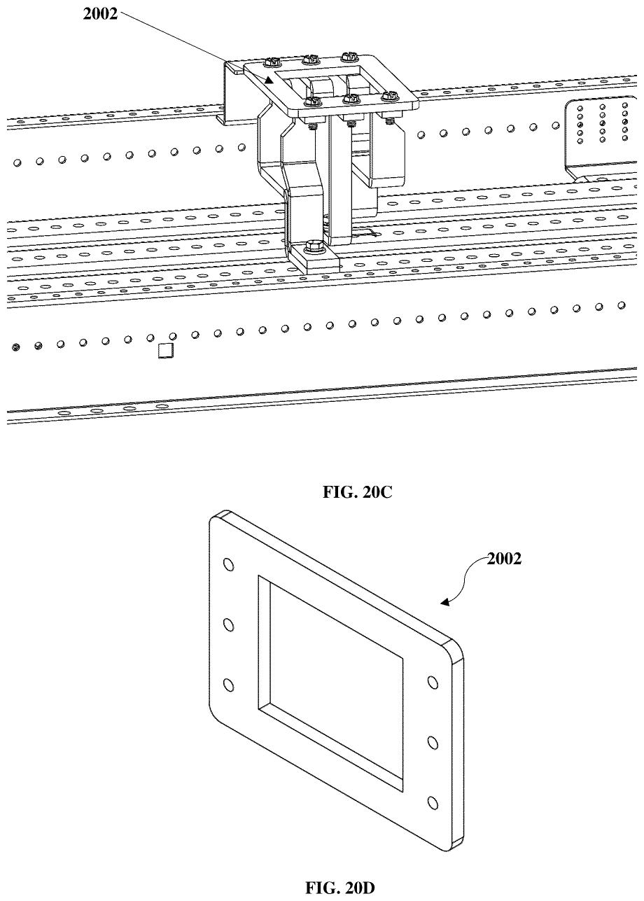

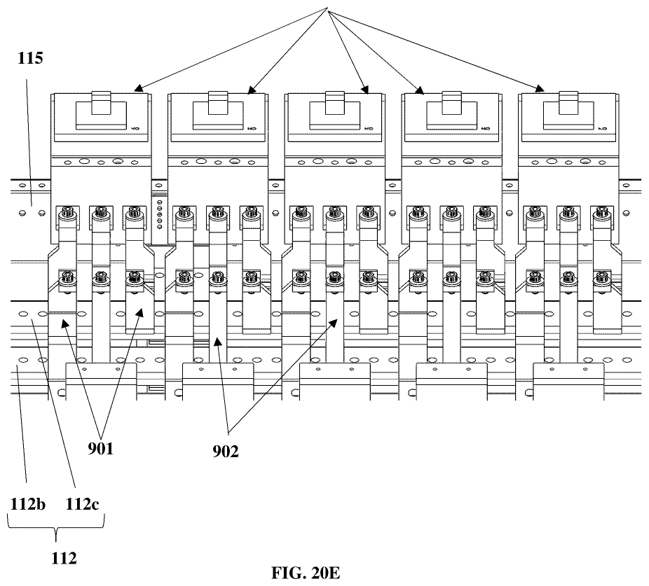

The bus bars 112a, 112b, and 112c of the main bus 112 of the modular high-density power distribution panel assembly (MHDPDPA) 100 are installed at the proper location by using a special chassis jig 2001 shown in the FIG. 20A. The jig 2001, separately shown in FIG. 20B, ensures proper spacing of the main bus 112 and maintaining a depth of 1.5″ from the top of the chassis 106 or Z rails 115, as illustrated in FIGS. 3A-3D and 4D. Additionally, the breaker bus straps are accurately spaced using a specialized jig designed specifically for each breaker. FIGS. 20C-20D illustrate breaker bus straps accurately spaced using a breaker jig 2002 designed for an ABB XT2 breaker. FIG. 20E illustrates one side of the twin-mounted XT2 breakers 904 with bus straps 901 and 902 all properly spaced to mount the XT2 breakers 904 on the other side of the MHDPDPA 100. It should be noted that although FIG. 20E illustrates XT2 breakers 904 on only one side, the bus 112 is aligned for accommodating twin breakers 904 on the other side.

The foregoing examples and illustrative implementations of various embodiments have been provided merely for explanation and are in no way to be construed as limiting the embodiments disclosed herein. Dimensions of various parts of the modular high-density power distribution panel assembly disclosed above are exemplary, and are not limiting of the scope of the embodiments herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

We claim:

1. A modular high-density power distribution panel assembly for large critical loads, the modular high-density power distribution panel assembly comprising:
an electrical enclosure;
a panel accommodated within the electrical enclosure, wherein the panel is defined by a configurable height and configured with a substantially high current rating, and wherein the panel is configured to flexibly accommodate a configurable number of breakers of a plurality of types and sizes in each of a plurality of rows with a substantially high current density;
a bus bar assembly comprising a main bus constituted by a plurality of bus bars operably coupled to the panel, wherein the bus bar assembly further comprises bus kits selectively configured to accommodate and support the configurable number of breakers of the plurality of types and sizes of different currents and current densities; and
a plurality of back stabs implemented in the bus bar assembly and configured to feed the main bus and support the configurable number of breakers of the plurality of types and sizes.

2. The modular high-density power distribution panel assembly of claim 1 configured to be rated at currents ranging from about 2000 amperes to about 6000 amperes and at a substantially high current density, free of cooling requirements.

3. The modular high-density power distribution panel assembly of claim 1, wherein the breakers comprise 80%-rated breakers and 100%-rated breakers, rated at currents ranging from about 100 amperes to about 1200 amperes.

4. The modular high-density power distribution panel assembly of claim 3, wherein 90° C.-rated cables are used for output connections of the 100%-rated breakers.

5. The modular high-density power distribution panel assembly of claim 3, wherein the breakers rated 100 A through 800 A are twin-mounted in the each of the plurality of rows on the panel, and wherein the breakers rated 600 A, 800 A, 1000 A and 1200 A are single-mounted in the each of the plurality of rows on the panel.

6. The modular high-density power distribution panel assembly of claim 5, wherein the breakers rated 800 A that are twin-mounted in the each of the plurality of rows on the panel achieve a current rating of about 1600 A per row of breakers.

7. The modular high-density power distribution panel assembly of claim 1, wherein the breakers are configured to accommodate 80%-rated loads and 100%-rated loads for high current density and application flexibility.

8. The modular high-density power distribution panel assembly of claim 1 configured as one of a wall-mounted power distribution panel, a standalone floor-mounted power distribution panel, and a switchboard-mounted power distribution panel.

9. The modular high-density power distribution panel assembly of claim 8, wherein the main bus of the bus bar assembly is directly connected to a switchboard cross bus in the switchboard-mounted power distribution panel.

10. The modular high-density power distribution panel assembly of claim 1, wherein the bus kits comprise bus straps configured to connect input terminals of the breakers of the plurality of types and sizes to the main bus.

11. The modular high-density power distribution panel assembly of claim 1, wherein the panel is configured to be connected to a low voltage switchgear via the bus bar assembly.

12. The modular high-density power distribution panel assembly of claim 1, wherein the panel is configured as one of a main lug only panel with a main lug only assembly, a panel with a main breaker assembly, and a switchboard bus-connected panel with a main breaker assembly.

13. The modular high-density power distribution panel assembly of claim 1 configured to achieve a high short circuit rating of about 200 kiloamperes (kA) at 480 V AC and about 100 kiloamperes at 600 V.

14. The modular high-density power distribution panel assembly of claim 1, further comprising lugs selectively configured for cable connections within the enclosure.

15. The modular high-density power distribution panel assembly of claim 1, wherein the configurable height of the panel corresponds to width of a largest one of the breakers.

16. The modular high-density power distribution panel assembly of claim 1, wherein the main bus comprises drilled and tapped holes configured thereon based on each of the types of the breakers.

17. The modular high-density power distribution panel assembly of claim 1 configured to meet stringent building codes, seismic standards, and predefined electrical requirements comprising American National Standards Institute (ANSI) requirements, Underwriters Laboratories (UL) requirements, Canadian Standards Association (CSA) requirements, National Fire Protection Association (NFPA) requirements, and National Electric Code (NEC) standards.

18. The modular high-density power distribution panel assembly of claim 1, wherein the bus bars are attached to a plurality of bus support members.

19. The modular high-density power distribution panel assembly of claim 18, wherein the bus support members are horizontal Glastic U shaped support brackets, wherein the horizontal Glastic U shaped support brackets are secured to the main bus, wherein each of the Glastic U shaped support brackets is secured to the main bus of each phase with two ¼″×20 screws that are 3 inches long, wherein each bus bar is constructed by stacking a plurality of conductive metal strips/bars, and wherein for each one of said bus bars comprising four pieces of the conductive metal strips/bars per phase, one piece of the conductive metal strip/bar closest to one of the Glastic U shaped support brackets is drilled and tapped and the remaining three pieces of the conductive metal strips/bars are drilled to slide them in place.

20. The modular high-density power distribution panel assembly of claim 19, wherein at locations of the main bus where one of the horizontal Glastic U shaped support brackets is secured to the main bus to support the main bus, said ¼″×20 screws that are 3 inches long secure the Glastic U shaped support bracket and a breaker bus strap.
